(19) United States
(12) Patent Application Publication
(10) Pub. No.: US 2001/0032335 A1
(43) Pub. Date: Oct. 18, 2001

(54) Picture communications system and associated network services

(76) Inventor: Lawrence R. Jones, San Diego, CA (US)

Correspondence Address: LAW OFFICES OF JAMES D MCFARLAND, 12555 HIGH BLUFF DRIVE, SUITE 280 A, SAN DIEGO, CA, 92130

(21) Appl. No.: 09/799,404

(22) Filed: Mar. 5, 2001

Related U.S. Application Data
(60) Provisional application No. 60/187,235, filed on Mar. 3, 2000.

(51) Int. Cl. H04N 7/173

(52) U.S. Cl. 725/105

(57) ABSTRACT

A real-time picture communications system (15) including a picture communications network subsystem (26) provides real-time picture communication services between users (21), devices (22), and/or groups of users, devices, and other groups. Examples of devices include cameras, viewers, keypads, writing tablets, microphones, telephones, and combinations thereof. One or more protocol communications nodes (27) are connected to one or more networks to provide communication between the network and the picture communications network subsystem. A registry database (28) includes user information (86), device information (87) and group information (88). A control subsystem (29) processes requests and executes instructions, such as an attach instruction and instructions that establish real-time communication services responsive to an authenticated request by a user or a device to the extent allowed by the various access rights of any users, devices and groups.

### CROSS-REFERENCE TO RELATED APPLICATION

Priority is hereby claimed to U.S. Provisional Application No. 60/187,235, filed Mar. 3, 2000, entitled A Picture Communications System and Associated Network Services.

### BACKGROUND OF THE INVENTION

1. Field of the Invention

This invention relates to communication systems, and particularly to systems for real time communication of information.

2. Description of Related Art

Despite the increasing use of electronic mail and other forms of electronic communication, the telephone system remains the most widely used and reliable forms of communication in the world today. The world is interconnected by a telephone network over which we speak and hear the spoken word, and engage in real time conversations to anyone, anywhere, at any time; for example a person in the U.S. can engage in a voice conversation with someone thousands of miles away in Europe, as if that person were in the same room. In summary, the telephone call is a fundamental and integral part of contemporary life.

Although a call to a distant telephone appears simple, it is actually the result of a complex interaction of underlying service providers and networks. Organizations are responsible for those networks, and working together to establish the standards that enable those networks to interconnect so perfectly. While many networks and service providers are involved, tight integration enables one to view it as a single public switched telephone network (PSTN).

The telephone system's great strengths-ubiquity, consistency, and reliability-rest squarely on technical standards that remain stable over the long term. One fundamental reason that telephones work so well is that they all work the same way; for example a person in the U.S. can telephone a person in Europe and be assured that voice communication will most likely proceed smoothly, without the frustrating incompatibilities experienced by other electronic forms of communication.

Since its inception, the telephone has largely remained a voice-oriented communication system. Other forms of communication, such as visual communication, have been largely ignored. Technical choices made nearly a century ago fundamentally constrain PSTN performance and design decisions. Although telephone lines are now commonly used to transmit data via modem or facsimile machines; this type of communication is not real-time. For example, facsimile (fax) machines are widely used to transfer monochrome printed images over the telephone network; however, fax use is limited primarily to documents and text for businesses due to the low resolution of faxed images, the relatively lengthy time period required to send a fax communication, and the performance compromises necessary to accommodate mechanical paper scanners and modem connections over a voice-grade dial-up switched circuit network.

Wide-ranging networks have been proposed and are under development to implement various forms of broadband communication. For example, the Third Generation Partnership Project (3GPP, see http://www.3gpp.org), the widely supported global wireless multimedia network initiative, proposes to serve our visual sense with video, providing dynamic, moving scenes. Unfortunately, video communication requires relatively large bandwidth, forcing a difficult tradeoff between image quality and cost control. Furthermore, video is difficult to reference, to sort, to store for ready retrieval, and to annotate when contrasted with still images. 3GPP does not propose real-time still image communications services such as envisioned herein.

When communicating a scene to another person, a still image can be much more practical and useful than video images. For example, a still image—a picture is—readily named, stored, annotated, and modified. A still image can be precisely discussed, referenced and recorded. High resolution still images can be sent over networks using a bandwidth far too low for comparable video resolution. Furthermore, still image display systems can be less costly and less complicated than video display systems.

Vision is our broadband sense. We see and take in a scene in an instant, and from that scene the mind rapidly identifies objects and forms associations. It would be useful if a system could provide real-time visual communication analogous to the telephone, allowing complex understanding to be achieved in a single moment from observation of a scene. It has been said that “a picture is worth a thousand words”, but in many instances even a thousand words cannot convey a single picture.

At the present time there is no practical way to share images and communicate visually in real-time from a distance. Digital cameras and scanners are two widely used devices that capture digital images. However, to view those images and send them to others, the digital still images are routinely transferred into a computer, from which they are printed, processed or transferred to a remote location. The Internet allows people to share still images via e-mail or via downloads from a remote server. To send an image by e-mail, one must capture a picture with a digital camera, transfer the picture file to a computer, attach the file to an e-mail, mail it to the distant party, and wait for that party to retrieve and open the mail. To share a picture using a remote server interface, a user must first capture a picture with a digital camera, transfer the picture file to a computer, upload the picture from the computer to the server. Then the recipient must log onto the server, access the picture, and download it. These approaches lack the immediacy, naturalness, symmetry and real-time interactive nature of a telephone call.

### SUMMARY OF THE INVENTION

A real-time picture communications system is described herein that is easy of use, technically sound, compatible with today's technologies, and likely to survive the test of time. A picture communications network subsystem is described that provides real-time picture communication services between users, devices, and/or groups of users, devices, and other groups. The picture communications network subsystem comprises one or more protocol communications nodes connected to one or more networks to provide communication between the network and the picture communications network subsystem. A registry database in the picture communications system includes user information for a plurality of users, including a user name that uniquely identifies each user, access information, and an owner of each user. The registry also includes device information for a plurality of devices, including a device name that uniquely identifies each device, access information, and an owner of each device, and group information for a plurality of groups that provide access rights to users, devices, and other groups, including a group name that uniquely identifies each group, access information, and an owner of each group.

The picture communications network subsystem includes a control subsystem that processes requests and executes instructions, such as an attach instruction for attaching a user to a device so that said user is associated with a device during the time period while the user is attached to said device. The control subsystem also executes instructions that establish real-time communication services between users, devices, and groups responsive to an authenticated request by a user or a device if allowed by the various access rights of any users, devices and groups involved in the request. The picture communication system for still images described herein can be implemented in a wide variety of forms, including such aspects as: (1) rapid device initialization, (2) alerting the intended recipient of the originating user's wish to share a still image, (3) acknowledgement by the intended recipient of readiness and willingness at that time to receive a still image from the identified originating user, (4) essentially immediate capture of a still image and transfer of that still image to the recipient, and (5) tools enhancing two-way discourse regarding the still image, such as compact representations of picture annotations and modifications providing an efficient way to share ideas relating to a specific still image among the two or more parties.

In one embodiment, the system enables an originating user (i) to initiate a contact with another user, (ii) to receive an essentially immediate response as to the remote user's device status and willingness to receive an image from said originating user, (iii) to capture and send the image essentially immediately, and (iv) to engage in a useful real-time exchange with the remote user regarding the image; all in a manner consistent with the spontaneous and immediate nature of a telephone call.

In some embodiments a real-time still image communications service could be made available to users in combination with real-time voice communications. For example, a complete network service offering might combine still image and voice telephone services in a single integrated package. In this example, a user could initiate a combined voice and picture call with a second user, discuss one or more still images, and receive and originate picture annotations.

In other embodiments, a still image network service might be deployed without voice services. In this case, the user might know two addresses carried by the intended recipient: a still image device address, and a cellular telephone number. With these two addresses, the originating user could establish a multimedia session supporting voice and still images by using two independently-deployed technologies.

In another embodiment, user names are distinct from device names in the still image network systems. In one such embodiment, a first user may attach to a particular device so that a second user can initiate contact with the first user by addressing the first user and employing network services to automatically recognize the association between the first user and device to which he is attached, and direct the contact to that device.

### BRIEF DESCRIPTION OF THE DRAWINGS

For a more complete understanding of this invention, reference is now made to the following detailed description of the embodiments as illustrated in the accompanying drawing, wherein:

FIG. 1 is a conceptual diagram of a system that provides still picture and other real-time network communication services between a first user who is using a first device and a second user who is using a second device.

FIG. 2 is a block diagram illustrating interconnections between users, devices, network interfaces, a network, and a picture communications network subsystem;

FIG. 3 is a block diagram of the communication system of FIG. 2, illustrating a real-time communication session set up between two users;

FIG. 4 is a block diagram of the communication system of FIG. 2, illustrating a real-time communication session set up between a user and a device;

FIG. 5 is a flowchart illustrating steps to establish a real-time picture communication session between a sender and a recipient;

FIG. 6 is a flowchart illustrating steps to establish a real-time communication session between a user and a remotely-positioned camera, and acquire a remote digital image from the remotely-positioned camera;

FIG. 7 is a diagram of a picture communication system, including devices, network interface examples, network examples including the internet, connected to a picture communications network subsystem;

FIG. 8 is a diagram of information in a registry, organized by user, device, and group;

FIG. 9 is a diagram of tiered groups, illustrating access rights;

FIG. 10 is a block diagram of a camera for sending picture files;

FIG. 11 is a block diagram of a viewer for receiving and displaying picture files;

FIG. 12 is a diagram illustrating a process of sending a picture file from a user's camera to a selected viewer in one embodiment;

FIG. 13 is a diagram illustrating the process of requesting a picture file from a selected camera in one embodiment, from a set of all immediately reachable cameras;

FIG. 14 is a diagram of an arrangement wherein a first user puts a picture file to a second user;

FIG. 15 is a diagram of an arrangement wherein a first user gets a picture file from a second user;

FIG. 16 is a diagram of an arrangement wherein a first user puts a picture file to a second user through a group filter;

FIG. 17 is a diagram of an arrangement wherein a first user gets a picture file from a second user through a group filter;

FIG. 18 is a diagram of an arrangement wherein a first user requests a picture file from a device through a group filter affiliated with a second user, and as a result the first user gets a picture file from the second user who is affiliated with a second group filter;

FIG. 19 is a diagram of an arrangement wherein a first user puts a first picture file from a device through a group exploder filter to multiple users, and at least one of the multiple users modifies the first picture file and puts it through a group filter to the first user; and

FIG. 20 is a schematic diagram illustrating a picture-file answering machine that may act as a surrogate for a viewer during periods when the viewer is available for a session.

### DETAILED DESCRIPTION

### Introduction

Future multimedia network plans invariably refer to voice, data and video service offerings. Targeted customers are presumed to want to browse the Web and view full motion video images from afar. In contrast to video communication services, the picture communications system disclosed herein provides a new class of still image visual communications services. Still images can be very useful, often far more useful than streaming full motion video. Still picture communications services enable usage models substantially different from existing and planned services. The following example scenarios illustrate situations in which still picture communication can be useful:

Scenario 1: A shopper calls home to ask “Which item do we need? This big one or this other one?” The shopper takes a picture of each item, and after a quick glance at the labels on the items, the answer is clear to the viewer at home-and not the answer that would have resulted from a verbal description.

Scenario 2: An inspector calls the office from the field, sends a picture of a nonstandard implementation to his supervisor and asks: “This looks different.

What do you think?” The supervisor immediately approves the alternative implementation based on remote inspection of the picture, and records the deviation in the permanent record.

Scenario 3: From across town, Mom calls up a real-time image of the children's playroom and is immediately assured that they are safe and secure, although awake.

As can be seen from these and other examples, still images offer distinct advantages over video and verbal communication, for example: (1) precision, because a still image enables two or more parties to review an identical specific picture, (2) simple referencing and archiving, because still images are readily indexed and stored, (3) higher available resolution of still images than video under typical constraints, and (4) economy, requiring only modest bandwidth and a relatively short time period to transmit a still image.

Described herein is an effective and practical picture communications system that is easy to use, technically sound, compatible with today's technologies, and likely to survive the test of time.

### System Overview

A system and method for communicating a still picture (“image”) over networks is disclosed herein. This invention is described in the following description with reference to the Figures, in which like numbers represent the same or similar elements.

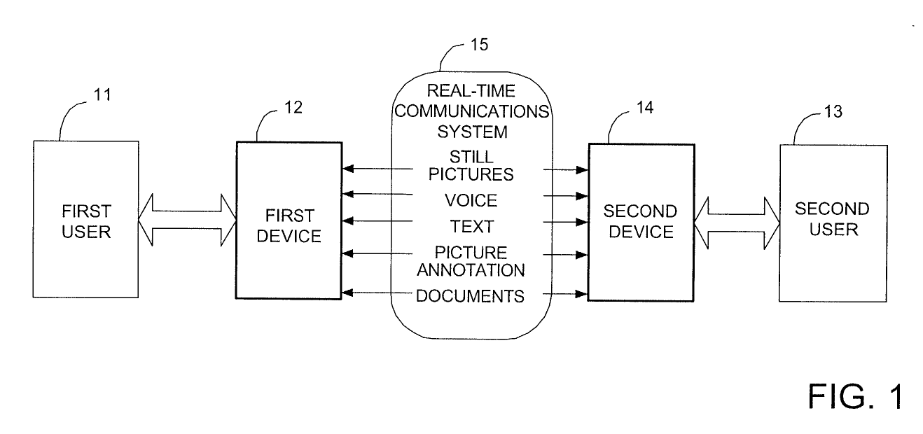

FIG. 1 is a conceptual diagram of a system that provides still picture and other real-time communication services for a session between a first user 11 using a first device 12 and a second user 13 using a second device 14, which is connected with the first device 12 using a communication network 15. In addition to still picture communication services, the system shown in FIG. 1 can also optionally provide other real-time communication services including voice communication, text communications, picture annotation services, and documents that are viewed simultaneously by both users by using their respective devices, and can be edited in real-time. Either the first user or the second user can initiate any of the communication sessions, and either can send and receive the still picture communication. In some implementations, the second user may be absent, in other words the first user may connect directly to the second device to request information without requiring immediate attention from the second user.

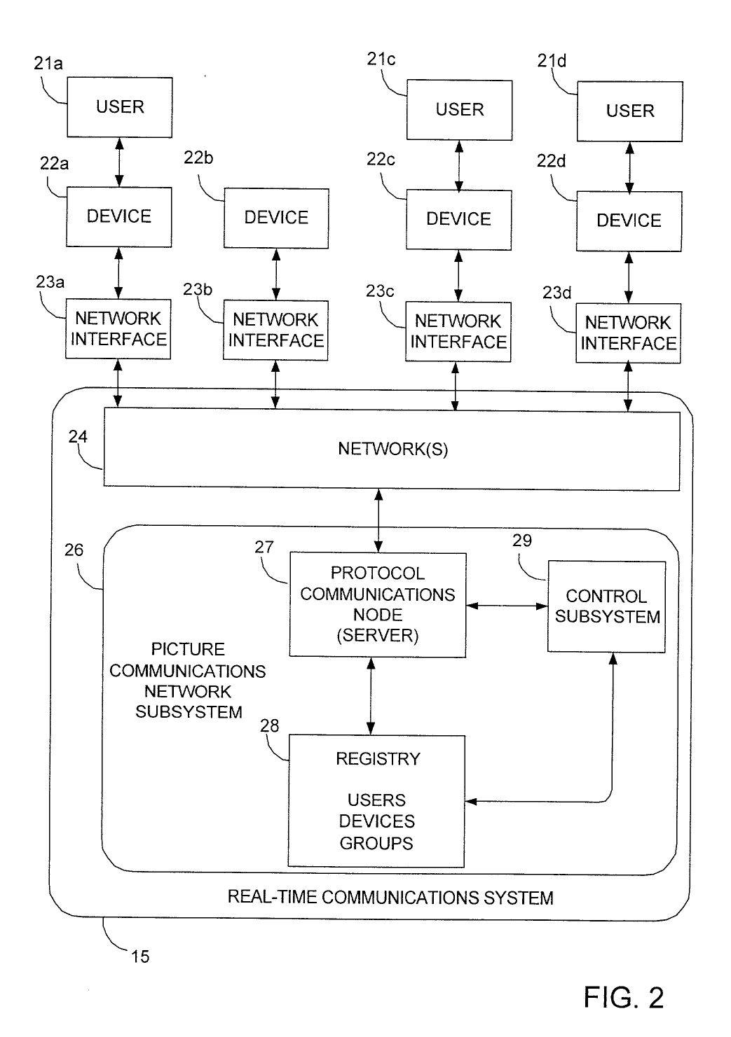

A user is a person or other operator who communicates with another user or device. A device is an apparatus capable of exchanging picture files with another device substantially in real time. A session is an association between two communicating end points for a period of time. A real-time communications system is a combination of a picture communications network subsystem and one or more networks, described with reference to FIG. 2 for example.

FIG. 2 is a block diagram of a plurality of users 21a, 21b, and 21d, devices 22a, 22b, 22c and 22d and network interfaces 23a, 23b, 23c, and 23d connected to a network 24. The network 24 may comprise a single network or a network of interconnected networks. In a simple example, the network 24 may consist of one or more devices directly attached to a picture communications network subsystem. In a more complex example, the network 24 may comprise a GSM network providing a General Packet Radio Service (GPRS) utilizing a GSM handset as the network interface 23a connecting through the public Internet to a cable television network utilizing a cable modem as network interface 23c that complies with the Data over Cable Service Interface Specification (DOCSIS™).

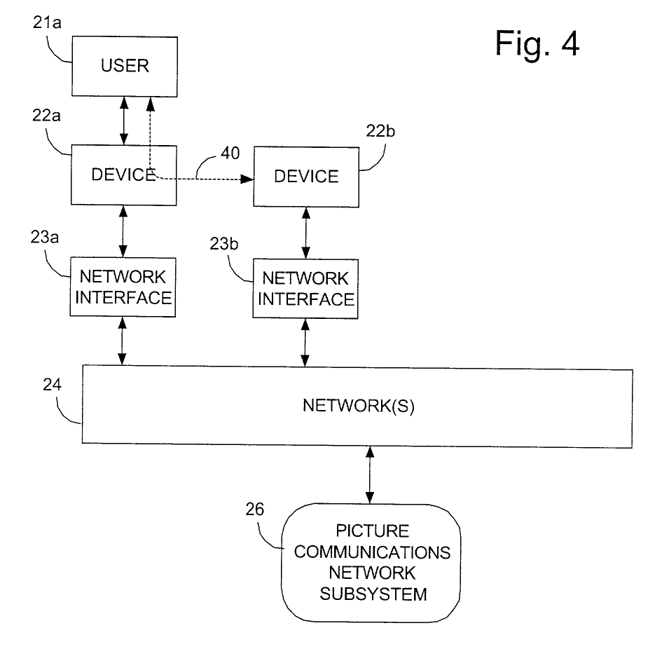

A network interface is a component or mechanism by which a device connects to a network. In a simple case, a network interface may consist of a serial port. In a more complex example, a network interface may comprise a combination of a Bluetooth™ wireless link to a GSM handset employing GPRS packet technology over a GSM network. In many instances, a user interacts directly with a device in order to communicate; for example, a first user 21a may interact directly with a device 22a, which utilizes a network interface 23a to connect with, and communicate over the network 24. However, as will be discussed with reference to FIG. 4, for example, in some instances a user is not necessary to operate the device, for example if the device is a remote camera that serves only to take pictures, an actual user is unnecessary except to set up the device. This is illustrated in FIG. 2 by a second device 22b, operating independently from any user, that utilizes a network interface 22c to connect with, and communicate over the network 24.

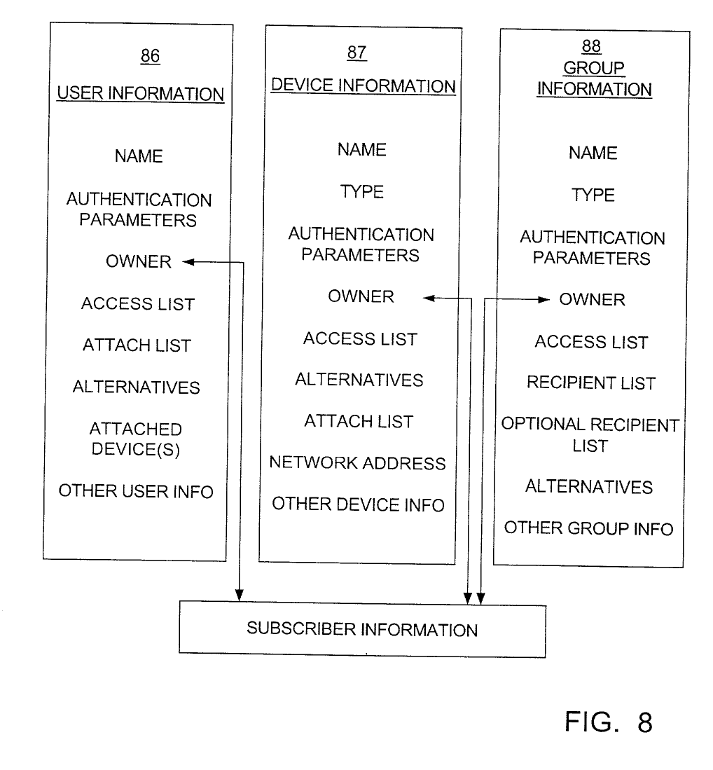

A picture communication network subsystem 26 is connected to the network to provide communication services that facilitate communication between the various users and/or devices. These services include a wide range of services, such as locating users on the network in response to a query, establishing communication services that allow two or more users to communicate in real-time, and support services. In order to provide these services, the picture communications network subsystem 26 includes one or more protocol communication nodes (termed herein “servers”) 27, a registry 28 that includes information about the users, devices, and groups, and a control system 29. The control subsystem processes requests and executes instructions, such as an attach instruction for attaching a user to a device so that said user is associated with a device during the time period while the user is attached to said device. The control subsystem also executes instructions that establish real-time communication services between users, devices, and groups responsive to an authenticated request by a user or a device if allowed by the various access rights of any users, devices and groups involved in the request. A registry is a database that stores and processes information regarding users, devices, and groups of users and/or devices. One example of a registry is described with reference to FIG. 8. Briefly, to keep track of devices and facilitate communication between the various devices connected to the network, the registry may include information such as the device name, owner, description, capabilities, and current network address. Using this information, the picture communications network subsystem 26 communicates with and otherwise facilitates communication between the devices. For example, to establish a real-time communication session between two or more users, the picture communications network subsystem 26 locates all users who are to participate in the session and sets up and establishes the services necessary to allow the users to communicate. Once the services have been established, the users may then communicate in real-time using these services directly without further intervention from the picture communications subsystem.

A picture communications network subsystem contains one or more registries. The picture communications network subsystem server 27 (FIG. 2) is a protocol processing communications node that provides picture communications transport services to devices and users, including for example relaying of queries to the registry, relaying of responses from the registry, and redirection of picture communications between users. The picture communications network subsystem, including registry and server functions, may be implemented within a single computer. Alternatively, registry and server functions, as well as other functions of the picture communications network subsystem may be implemented in different computers and even in different locations.

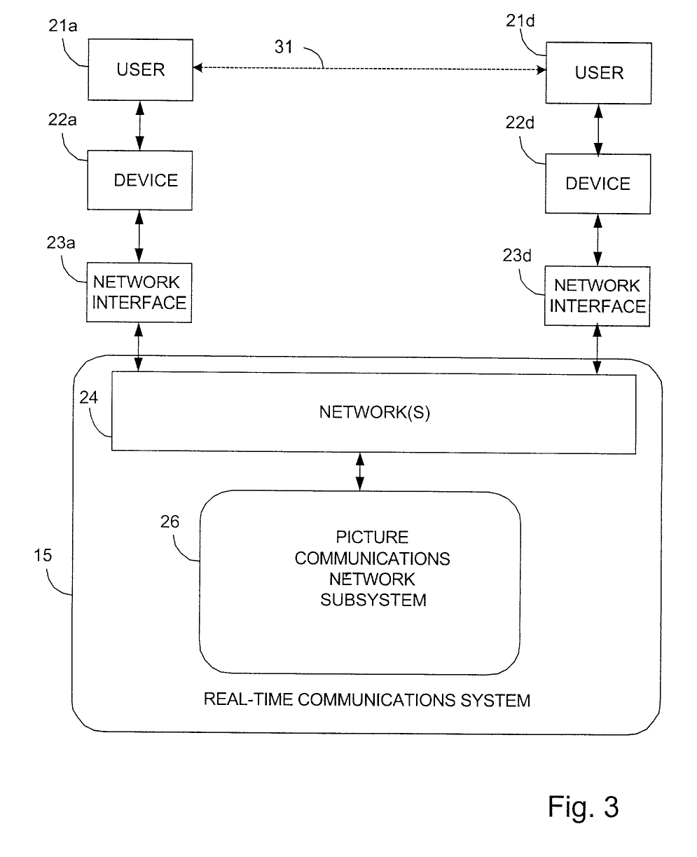

FIG. 3 is a block diagram of the communication system of FIG. 2, illustrating a real-time communication session 31 that has been set up between the first user 21a and the fourth user 21d by the picture communications subsystem. Conceptually, since the session 31 has been established, the session is now directly between the first and fourth users; i.e., the underlying devices and services become transparent to the users. However, in actuality, the physical signals exchanged between the two users 21a and 21d follow a path through device 22a, the network interface(s) 23a, the network 24, the network interface(s) 23d, and device 22d.

FIG. 4 is a block diagram of the communication system of FIG. 2, illustrating a real-time communication session 40 that has been set up by the picture communications subsystem between the first device 21b attached to the first user 21a and the second device 22b. Conceptually, since the session 40 has been established, the session is now directly between the first user 21a and the second interface device 22b; i.e., the underlying devices and services become transparent. However, in actuality, the physical signals follow a path from device 22a, through the network interface(s) 23a, through the network 24, through network interface(s) 23b, and then to device 22b.

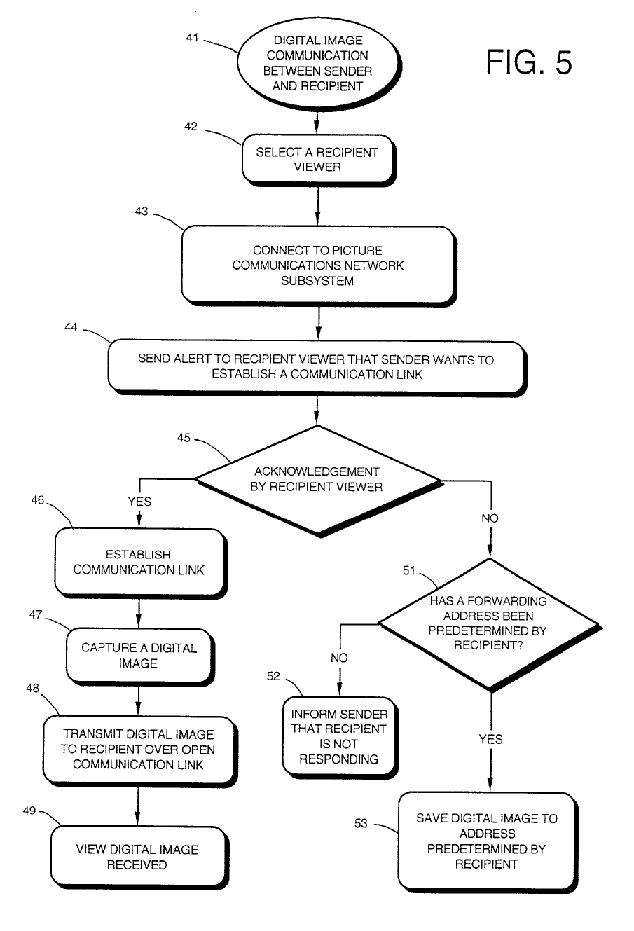

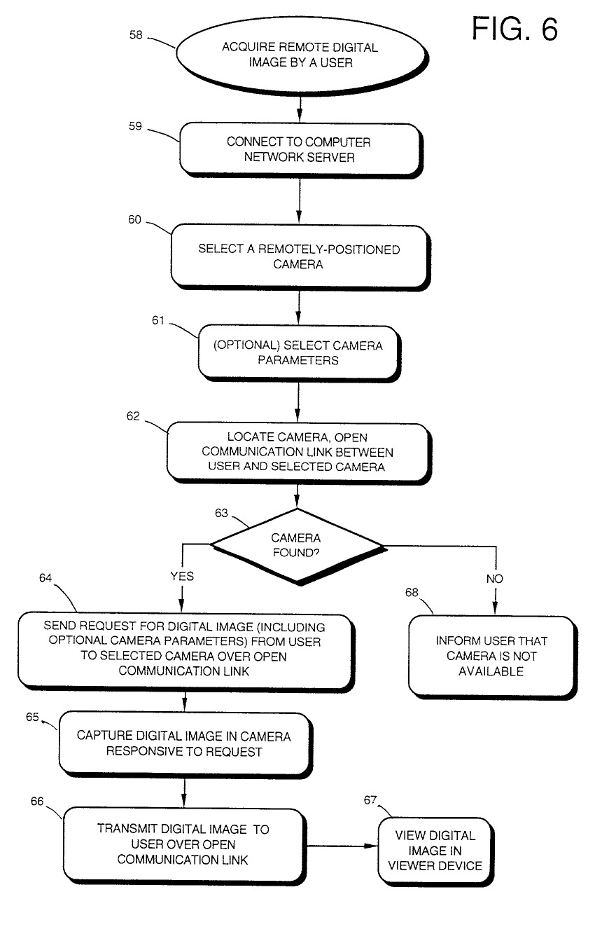

Using the system described herein, a wide variety of communication sessions can be established and utilized for real-time communication. FIGS. 5 and 6 are flow charts illustrating two examples of such communication sessions; many other examples are possible.

As in any fully formed real-time communication network, many possible functions are possible, which are made up of a series of operations. FIGS. 5 and 6 show examples of two such functions. FIG. 5 is a flow chart of operations to set up and establish real-time communications between two users, identified as a sender and a recipient. Operations to send a digital image from the sender to the recipient begin at box 41, and at 42, the sender selects one or more recipient users and/or viewers. At box 43, the sender connects to the picture communications network subsystem 26. At box 44, the picture communications network subsystem locates the recipient viewer and sends an alert notifying the recipient that the sender wants to establish a communication session. At decision box 45, if the recipient viewer acknowledges, then operation moves to box 46 in which the picture communications network subsystem establishes a communication session between the sender and the recipient. At box 47 the sender captures a digital image. Alternatively the sender can choose to send a previously saved digital image. Then at box 48 the sender transmits the digital image to the recipient over the open communication session. At box 49, the recipient user views the image on the viewer device. After this, the sender and recipient can engage in other communications over the real-time session; for example, the sender and recipient may converse using telephone-like services, and/or the recipient may annotate the image using a keypad or a tablet to create a picture modification file, and return the picture modification file to the sender for review and discussion.

Still referring to FIG. 5, if from the box 45 the recipient does not acknowledge the alert from the server, or if a communication session cannot be established, then operation moves to box 51 in which the picture communications network subsystem 26 determines if a forwarding address has been predetermined by the recipient. If there is no forwarding address, then operation moves to the box 52, and the sender is informed that the recipient is not responding. However, if there is a forwarding address, then operation moves to box 53, in which the picture communications system server sets up a session with that forwarding address. and the sender can capture a digital image, and save it to the address predetermined by the recipient. In addition, the sender may also save other information to the device at the forwarding address, such as a voice message. Alternatively, a forwarding address predetermined by recipient may direct the query to another device or user, in which case the process is re-entered at step 44 where the picture communications network subsystem 26 sends an alert to the predetermined alternate viewer/user address.

FIG. 6 is a flow chart of operations to set up and establish real-time communications between a user and a device, identified as a remotely-positioned camera, for the purposes of acquiring a real-time digital image. Operations to acquire a digital image from a remotely-positioned camera begin at box 58, and at 59, the user connects to the picture communications network subsystem 26. At box 60, the user selects a remotely-positioned camera. At box 61, if desired, the user selects camera parameters. At box 62, the picture communications system locates the selected camera and attempts to establish a real-time communication session between the user and the camera. At decision box 63, if the camera is found and a communication session is established, then operation moves to box 64 in which the user sends a request for the remote camera device to capture and send a digital image over the real-time communication session. At box 65 the camera captures a digital image, and then at box 66 the digital image is transmitted to the user over the open communication session. At 67, the user views the image. After this, the user can request additional images from the camera and/or request additional information, such as sound if the camera includes a microphone. However, if at box 63 the camera is not found or the communication session cannot be established or if the user does not have access rights to the camera device according to Registry records associated with the camera device, the user is informed that the selected camera is not available.

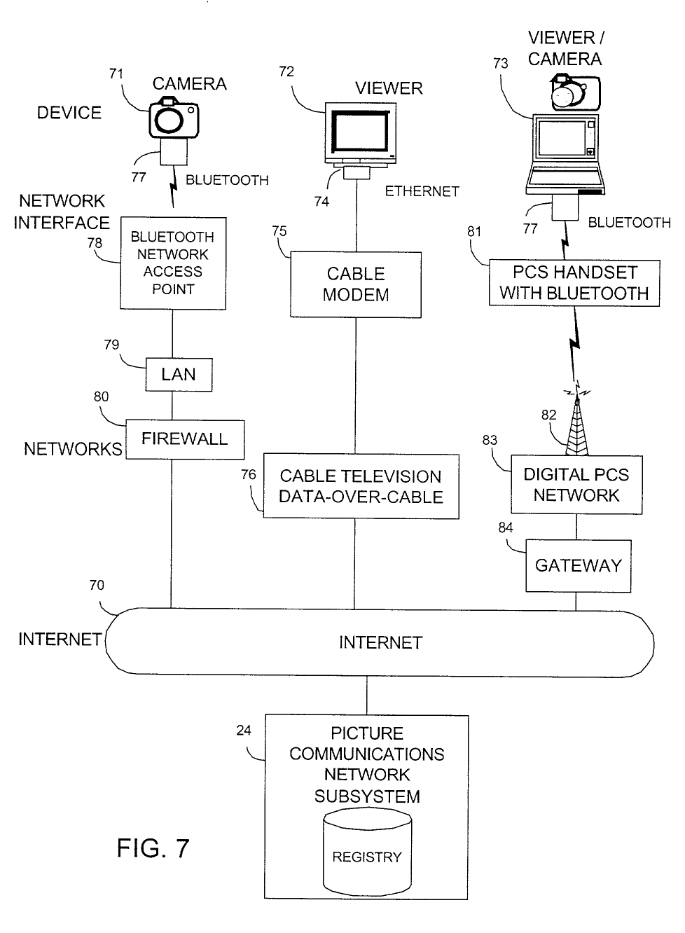

FIG. 7 is a diagram of a picture communications network, showing examples of user interface devices, network interface devices, and networks, connected via an Internet 70 to the picture communications network subsystem 26, which supervises and facilitates communication between the devices connected thereto. The Internet 70 is a widely used, world-wide electronic communication network, and provides a suitable network from which to implement the picture communications system, and connect to the network subsystem 26. In other embodiments, the network subsystem 26 can be connected directly to other networks, in addition to, or in place of the Internet.

In the examples shown in FIG. 7, the user devices include a camera 71, a viewer 72, and a combination viewer-camera 73. The camera 71 may comprise a suitable digital camera that may also capture an image in a selected digital format and save it in a memory card within the camera. The camera 71 may include a system for communicating the digital image at the same time as the images is captured, and it may include a system for communicating the digital image before the image is saved on the memory card, thereby allowing real-time communication. The viewer 72 comprises any suitable viewing media, such as an LCD screen that can display an image substantially when received for real-time communication. The combined camera-viewer 73 comprises a combination of both the camera and viewer 72. Any of the user interface devices 71, 72, and 73 may also include, in the same package, one or more network interfaces.

A first network interface example shown in FIG. 7, the viewer 72 is connected to an Ethernet adapter 74, which is connected to a cable modem 75, which is connected a cable television head end and gateway 76, which is in turn connected to the Internet 70. In a second network interface example, the camera 71 is connected to a Bluetooth® adapter 77, a Bluetooth™ node host 78, and a Local Area Network (LAN) 79, which is connected to the Internet 70. In this example, a firewall 80 is situated between the LAN 79 and the Internet 70 in order to provide security to the LAN. In a third network interface example, the viewer/camera 73 is connected to a Bluetooth™ wireless adapter 77, a digital PCS handset 81 with a Bluetooth® wireless adapter that transmits over a wireless wide area network such as a digital PCS network 82 utilizing GSM or CDMA technology, and then to a data services gateway 84 that connects to the Internet 70.

FIG. 8 is a diagram of the fields in one example of the registry 28. As discussed briefly with reference to FIG. 2, the registry stores information on users, devices, and groups. The registry information for one embodiment is illustrated in FIG. 8; other embodiments may contain different or additional information as appropriate to meet the desired purposes.

The registry shown in FIG. 8 includes three sets of records: user information shown at 86, device information shown at 87, and group information shown at 88. In addition, subscriber information is shown at 89. The database structure may vary between embodiments; considerations such as scalability, security, subscriber service, fraud mitigation, and other factors can lead to structural variations. For example, the user information for each user may be stored with a user record, the device information for each device may be stored in a device record, and the group information for each group may be stored in a group record.

User information 86 includes a user name that is unique within the namespace utilized by the registry. Additional user information stored within the registry includes information necessary to authenticate the user (e.g. a password), access information such as a list of other users and devices with rights to access that user, the identity of a device to which the user is attached, and the owner, who has the right to change and update user information. In some embodiments, the authentication information comprises a secure authentication algorithm and necessary keywords which may, for example, be similar to that used by a GSM network to authenticate a GSM subscriber identity module (SIM). The owner of a user may be that user; that is, the person who is the user may also serve the function of owner of that user identity within the registry. Additional information about the owner may be stored in the form of subscriber information 89, which may include information such as billing information, address, phone number, and so forth. Optionally other information about the user may be included in the registry, such as informal ID (e.g. handle) and usage history.

Device information 87 includes a device name that is unique within the namespace utilized by the registry. Additional device information stored within the registry includes (i) information necessary to authenticate the device (e.g. a secure authentication algorithm and necessary keywords which may, for example, be similar to that used by a GSM network to authenticate a GSM international mobile equipment identifier (IMEI).), (ii) access information such as a list of other devices and users with rights to access that user, (iii) the (dynamic) network address of the device, (iv) the owner, who has the right to change and update device information, and (v) class (e.g. camera, viewer). Additional information about the owner may be stored in the form of subscriber information 89. Optionally other information about the device may be included in the registry, such as device description, alternate addresses for forwarding requests, and so forth. In one embodiment a large amount of flexibility is provided in defining the access rights; particularly the access information regarding a device may identify (i) groups associated with that device, (ii) users and devices which may send picture files to and receive picture files from that device, and (iii) users who may establish control of (attach to) that device. Also, a device may be named in a recipient list of a group, so that any picture file sent to that named group will be sent to that particular viewer device as well as all other devices associated with that group.

A group is a set of users, devices, and other groups. Group information 88 includes a group name that is unique within the namespace utilized by the registry, recipient information such as a list of devices, users and other groups who may receive information from access requests directed to that particular group; access information such as a list of devices, users, and other groups with rights to access members of the recipient list as a group. Additional group information stored within the registry includes information necessary to authenticate the owner (e.g. a password, or alternative secure authentication algorithm and keywords), and the owner, who has the right to change and update group information. Additional information about the owner may be stored in the form of subscriber information 89. Optionally other information about the group may be included in the registry, such as type, and so forth. In one embodiment a large amount of flexibility is provided in defining the access rights; particularly the access information regarding a group may identify (i) other groups whose access list members may access that group as if listed individually with access rights, and (ii) users and devices that may send picture files to members of the recipient list of that group by the single action of sending a picture file to said group, and (iii) users and devices that may request picture files from all members of the recipient list of that group by the single action of sending said request to said group. As an example of the first case (i), a particular viewer device may be listed on the recipient list of a particular group, so that any picture file sent to that named group will be sent to that particular viewer device as well as all other devices named on the recipient list of that group.

One special type of group is called a public group. Except in the case when usage restrictions do not allow, any device attached to a public network is granted access privileges to other devices that are members of the public group.

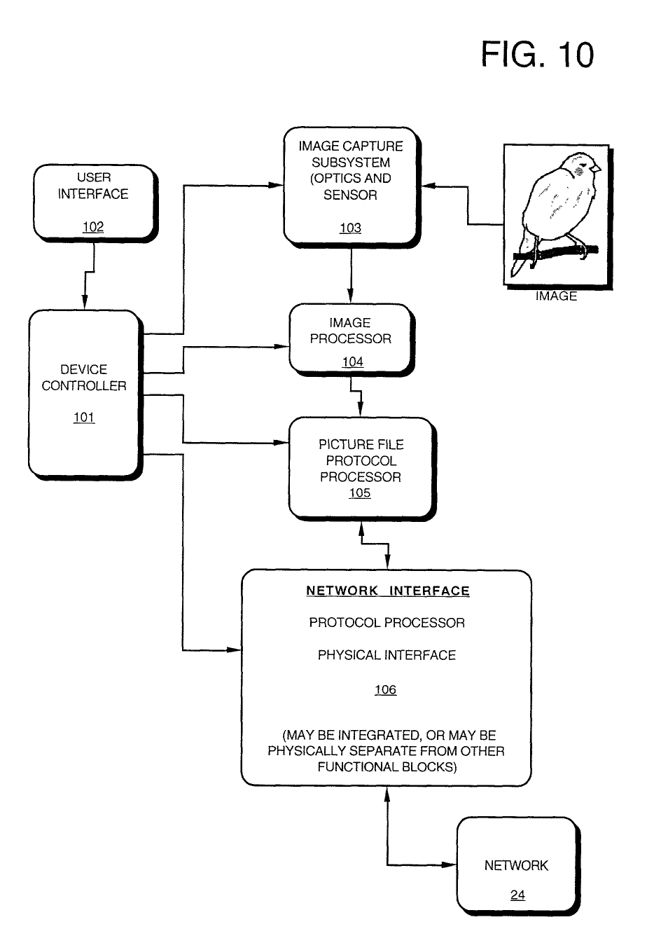

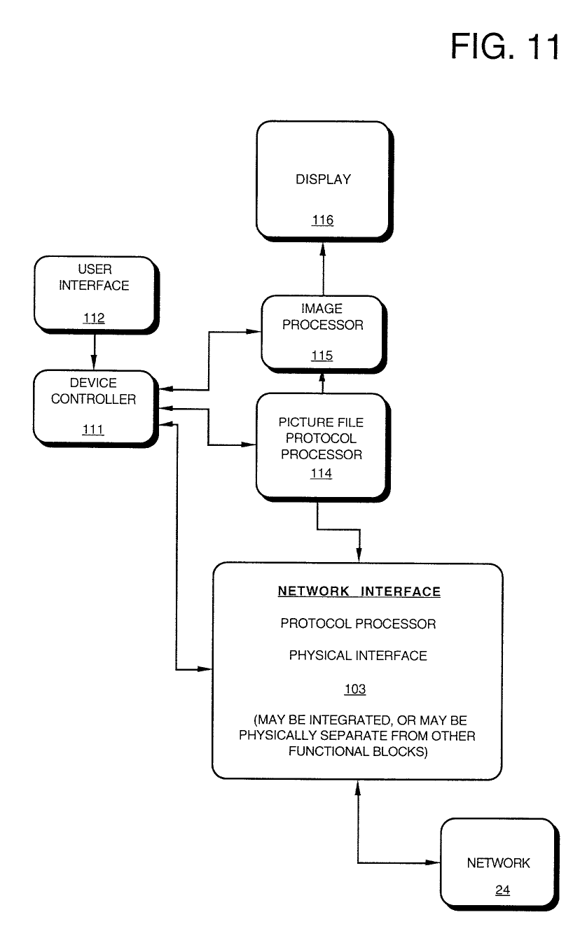

A device, such as described with reference to FIGS. 10 and 11, can attach to a network and execute a picture communications system protocol for the purposes of communicating with a registry and communicating picture files with other devices. A device may be a viewer, a camera, or a combination of viewer and camera. A user may become attached with a device within the registry, which sets up a session between the user and the device, If the registry knows to location of a device and also knows the user to which the device is attached, then the registry can use that device to set up a communication session with that user. A user becomes attached with a device by an attach process to be described, and a user becomes de-attached from a device by a detach process.

Subject to restrictions imposed by the operator of a picture communications system (such as establishing credit worthiness as a subscriber), any entity may register to become a user on the registry using any suitable system, such as a Web interface or direct telephonic communication; the entity that registers a user becomes an initial owner of that user. Likewise, any user may register a device, and that user becomes the owner of that device. Devices can be registered on a registry via a network by interaction between picture communications client application software running in the device and picture communications server application software running on the registry host; an owner must complete the registration using information to authenticate device ownership. Device associations and rights are set by the owner of the device.

In general, an owner is allowed to modify the registry record of the owned entity. Particularly, the registry record of every device identifies an owner of that device, the registry record of every user identifies an owner of that user, and the registry record of every group identifies an owner of that group. An owner may be a user and an owner may be a group. The owner of a user record in the registry may be that user. Alternatively, the owner of a user record in the registry may be a different registered user, and the owner of a user record in the registry may be a group. For example, an owner of a device may identify groups and users allowed to access that device. An owner of a group may change the names on the access list and the recipient list of the group. A current owner of an element (whether user, device or group) may change the owner name of that element to any other user or group, after which that other user or group becomes the current owner of said element. As another example, each device has an owner, who sets access rights to a device by specifying a list of users, devices, and groups that have access rights to the device. An owner may register a device as a member of a group, so that a user of the device may send picture files to the group and may receive picture files from the group. An owner is typically considered the subscriber for the purposes of billing for network and registry services used by a device.

An owner of a group may allow all or certain users to join a group, which means that such a user causes that user's name to be included in the recipient list of that group. An owner of a group may specify that certain users may join by naming groups as optional recipients. This technique enables what may be termed “opt-in” group membership.

A user may be added to the recipient list of a group as a result of an action by the owner of that group and an action by the owner of that user; where the action of one party places the user name on the optional recipient list, and the action by the remaining party causes the name to move from the optional recipient list to the recipient list. The owner of that group may indirectly add a user by including on the optional recipient list a group in which that user is on the recipient list.

In groups, circular ownership is not allowed in some embodiments. For example, If group A is the owner of group B then group B may not be the owner of group A, and if user A is the owner of group B then group B may not be the owner of user A, and if user A is the owner of user B then user B may not be the owner of user A. Similarly, indirect circular ownership is not allowed. For example if user A is the owner of user B which is the owner of user C then user C may not be the owner of user A, and so forth.

### Access and Attachment

Access refers to the right to connect to a user or a device over a network for the purpose of establishing a real-time communication session, and possibly exchanging a picture file. For example, if user A has access rights to device B, then user A can connect to device B. In this example, if device B is a viewer then user A has the right to connect to device B for the purpose of sending a picture file to device B. Access rights to each device are identified in the registry for every device and access rights for each user are also identified in the registry. Device access rights include the right of a user to access that device and the right of a member of a group to access that device. Device access rights are set by the owner of that device.

Access rights are identified in the registry for every device and for every user. Device access rights include the right of a user to access that device and the right of a member of a group to access that device. Similarly, user access rights include the right of a different user to access that user and the right of a member of a group to access that user.

Attaching to a device refers to the process of establishing control over that device. Every device includes an attach list that identifies users who may (and groups whose access list members may) attach to that device. Device attach rights are set by the owner of that device.

A user may attach to a device for a period of time, during which time the access rights pertaining to that user are attached to that device. For example, a user may gain physical control of a viewer device and then initiate an attach process including authenticating the user to the registry by means of a communications element within the viewer device. If successful, the user becomes attached to the device and remains attached until the user is detached from the device. A detach operation may be invoked by the user, by the device or by the registry, for example. A detach operation may be initiated any one of several events, such as (a) express release invoked by the user, (b) expiration of a timer within the viewer device, (c) expiration of a timer within the registry, (d) receipt by the registry of a detach command from the owner of the device, (e) failure of the device to successfully re-authenticate the user upon request by registry, and (f) failure of the user to successfully re-authenticate upon request by the device.

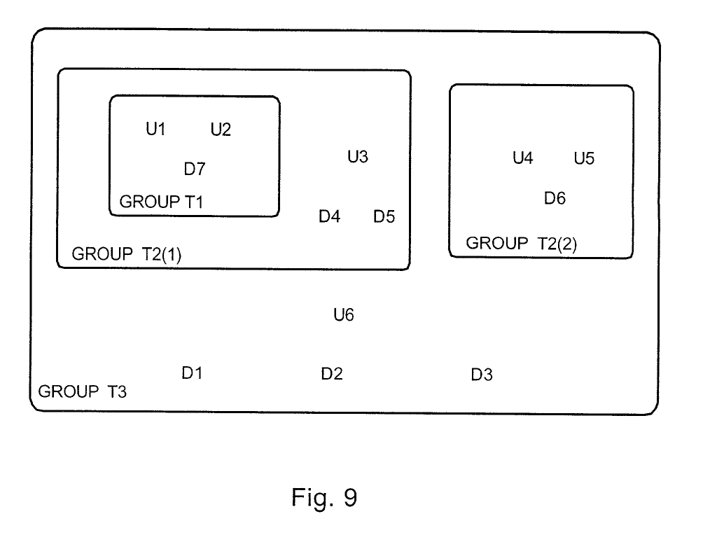

FIG. 9 is a diagram illustrating access rights of one type of group-a tiered group. These tiered groups provide a useful example of device attach rights pertaining to users and groups. In example shown in FIG. 9, six users U1, U2, U3, U4, U5 and U6) and seven devices D1, D2, D3, D4, D5, D6 and D7) are registered as members of tiered groups T1, T2(1), T2(2) and T3. Assume user U1 may attach to device D7. While U1 is attached to D7, an attempt by a different user to send a picture file to user U1 will result in an alert on device D7, and an attempt by a remote user to send a picture file to user U2 will not. A picture file sent to group T1 will arrive at device D7 while D7 is attached to user U1 and while detached.

Continuing the example in FIG. 9, it can be seen that user U2 is a member of groups T1, T2(1) and T3, while device D3 is a member of group T3. User U2 may attach to viewer device D3. While U2 is attached to D3, D3 receives picture files directed to user U2, group T1, group T2(1), group T3, and device D3 but does not receive picture files directed to group T2(2). When detached, the viewer device D3 receives only those picture files directed to group T3 and to viewer device D3.

A user may attach to a device associated with a public group by using the device to inform the registry that the user is controlling the device. During the period while the user is attached to the device, the rights and group memberships associated with the user are attached to the device as well as the user.

For example, user K may approach a viewer that is publicly accessible. User K invokes a login procedure during which the user authenticates identity and asserts control over the device, and initiates picture communications with user L who is currently attached to another registered device. While user K remains attached, user M attempts to access user K resulting in user K receiving an alert and deciding to accept a picture file from user M. Depending upon the capabilities of the viewer device to which user K is attached, user K may then continue to interact with both user L and M while remaining attached to the viewer device.

Exchange of a picture file between users is accomplished by reference to attach status within the user record of the registry. Consider an example, in which user A is attached to camera device B and initiates a request to deliver a picture file to user C. The registry finds user C is attached to viewer D and that user A has access rights to user C. Registry routes a request to viewer D which alerts user C of the request from user A. User C accepts the request directly to user A, together with the address information for device D to which user A then sends the picture file from device B.

In this example, when user B accepted the alert from user A, user B exercised the option of addressing user A directly and inviting user A to send the picture file directly to user B. Alternatively, user B could accept the alert from user A by way of the registry with an indication that user B wishes the registry to utilize an anonymizing relay service of a protocol communications node (i.e. server). In this alternative, the server relays the acceptance from user B to user A and provides user A with the address of the server for the picture. User A sends the picture file to the server for relay to user B.

### Device Implementations

Devices may be implemented in any of a wide variety of apparatus, including cameras that may be used to create and communicate picture files, viewers that may be used to view and communicate picture files. A device may connect to a network, possibly through one or more intermediate elements, for the purpose of communicating picture files. A single device may include the functions of a camera and a viewer.

A camera is a device such as discussed with reference to FIG. 10 that includes an image capture subsystem and a communications subsystem suitable for communicating with a picture communications network subsystem utilizing a prearranged protocol. A camera may optionally include storage, a microphone, a display, a touch screen, a keypad, a flash unit and other elements.

A viewer is a device such as discussed with reference to FIG. 11 that includes a display and a communications subsystem suitable for communicating with a picture communications network subsystem utilizing a prearranged protocol. A viewer may optionally include storage, a keypad, a keyboard, a touch screen, a speaker, a microphone, and other elements. For example, one embodiment may include a viewer, a camera, a keypad and a telephone, which could be useful for communicating with another user who has a similar device. Another embodiment may include only a camera and a microphone, which can be useful for remote-image capturing. A wide variety of configurations using various combinations of user interface devices for realtime communication are made possible by the communication system described herein.

FIG. 10 is a block diagram of an example of a camera, illustrating functional blocks including a device controller 101 that receives instructions from a user interface 102 that comprises, for example, a shutter button, a mode selection wheel, and a series of menus and submenus. The device controller 101 is also connected to an image capture subsystem 103, including lens optics and sensors, for example, that are used to capture an image. An image processor 104 is coupled to receive the image from the image capture subsystem 103, subject to control from the device controller 101. A picture file protocol processor 105 is coupled to receive the image from the image processor 104, subject to control from the device controller 101, and process the image data to provide a picture file in a format predetermined by a suitable standard. A network interface 106 is coupled to the picture file protocol processor 105 and the device controller 101 to provide an interface to provide communications functions with the network 24 to transmit the picture file. In this example, the network interface 106 is integrated within the camera; in alternative embodiments the network interface 106 is situated externally. The network interface 106 includes, for example, a protocol processor and a physical interface such as a cable connection (e.g. an Ethernet 10-base-T connector or a wireless interface.

FIG. 11 is a block diagram of an example of a viewer for viewing picture files, showing functional blocks including a device controller 111 that receives instructions and information from a user interface 1 12 and a network interface 1 13 coupled thereto. Communications functions between the viewer and the network 24 are provided by the network interface 113, which includes, for example, a protocol processor and a physical interface such as a cable connection (e.g. an Ethernet connector or a wireless interface. In this example, the network interface 113 is integrated into the viewer; in alternative embodiments the network interface 113 is situated externally. A picture file protocol processor 114 is coupled to receive a picture file in predetermined format from the network interface 113. The protocol processor 114 processes the picture file into a form suitable to be processed by an image processor 115. A display 116, such as an LCD screen, is coupled to display the image data received from the image processor 115.

In some embodiments, the camera and viewer could be combined in a single integrated package; in such embodiments, some of the functional blocks can be shared and integrated into a single block, for example a single image processor can perform the image processing functions for both the camera and the viewer, a single picture file protocol processor can provide picture file processing functions for both the camera and the viewer, and a single network interface device can provide communication functions for both the camera and the viewer. As discussed previously, a number of other devices, such as a telephone, microphone, keypad, and so forth, can also be integrated in a single package, and it should be apparent that some functional blocks can be shared, such as the network interface device block, depending upon the configuration of any particular embodiment.

### SYSTEM DESCRIPTION

### System Design Considerations and Requirements

A picture communications system can create a new class of communications services, offering the visual equivalent of a telephone call. For example, picture communications services can enable a user to contact a remote user and deliver a freshly captured picture to that party when the call is accepted. Picture communications services can also allow a user to capture a fresh picture from a remote camera selected from a directory.

In one embodiment, natural, intuitive picture communications implemented by adding key elements to existing network infrastructure, and implementing certain functions within relevant user devices. In what follows, the underlying design considerations are described, then a framework for a solution is described, and then the elements of that solution are described.

To design an effective, practical picture communications system, the following design factors should be considered. It should be apparent that in any real-world embodiment, there will be trade-offs between the various design considerations, which will be resolved by the scaled importance of each consideration:

Simple. From the perspective of the user, devices and services should be self-evident, recognizable, easy to use, readily understood, and intuitive to be adopted and used by the broad population.

Universal. Services should be widely accessible using existing networking infrastructure.

Standard. Devices and services should interact using a protocol which defines commands, procedures, and file structures in sufficient detail to ensure interoperability.

Real time. Response times should be sufficiently short to ensure that the user experience is substantially immediate.

Interactive. Users should be able to mark, annotate and otherwise manipulate a specific shared image while maintaining synchronized views of that image.

Secure. Users should be confident that an image is transferred securely, free from unlawful interception.

Addressable. Devices should be individually addressable in a consistent and stable manner.

Discoverable. A public registry is required so that device addresses can be located and basic characteristics of a device can be determined.

Accountable. Mechanisms should enable accounting for device and network services usage, in a manner that allows flexible business arrangements to be accommodated.

Forward compatible. Evolution of protocols, devices capabilities and network services is inevitable and should be considered in system planning.

Each of these features or characteristics is addressed in a following section.

### Simplicity

Sharing and discussing a picture is a natural act. A picture communications system should not intrude on that natural activity. Devices and system use should be virtually obvious to the end user, so that a typical consumer can use basic functions without detailed instructions.

Simplicity applies to using picture communications; to initiating a session during which pictures may be shared, manipulated and discussed; and to initiating service for a new device. A simple, automatic device registration method is envisioned whereby a device can join the picture communications system with default parameters, and the owner can modify the registration through the Web to set the desired characteristics for the device. A simple method is envisioned whereby a user of one device may initiate contact with another device and thereby alert a user at that other device, allowing that user at another device to accept the contact and engage a session between the two devices, and then to efficiently exchange, manipulate and discuss pictures.

Simplicity also extends to service parameters, in which the range of technical options are tightly constrained to ensure that all devices interoperate without coordination. The public switched telephone network (PSTN) shares this characteristic, in that voice telephone calls are constrained to a passband of approximately 300 Hz to 3000 Hz, and the signal is mu-law companded and waveform encoded at 64 kbps, resulting in limited fidelity but maximum interoperability.

### Universal

Today's networks allow a consumer to purchase a telephone, order a telephone line from the local telephone service provider, plug in the telephone and place a call to another party already on the network, without making special arrangements with the called party.

Similarly, if a consumer purchases a computer with Internet browser preinstalled, and arranges Internet access through an Internet Service Provider (ISP), the consumer can reach a broad array of Web-based information services without making arrangements with the Web site owners.

A picture communications system should make use of existing networks so that a new device owner does not need to make special arrangements with another party to share pictures with that party. A picture communications system should allow a consumer to acquire a device, connect to an existing network, register transparently, and use the device to share a picture with a remote device without technical assistance.

### Standards and Specifications

A picture communications system specification should define a system architecture, file structures, commands, procedures and protocols for communicating between devices and other system elements. Picture communications system test specifications should define test cases so that devices and system elements may be certified for compliance with picture communications system specifications to ensure interoperability.

According to the Open System Interconnection (OSI) reference model, as presented in ISO 7498 and CCITT X.200, network services and protocols can be described within a seven-layer framework in which each layer provides services to the layer above. From top to down, the layers include (1) application layer, (2) presentation layer, (3) session layer, (4) transport layer, (5) network layer, (6) data session layer, and (7) physical layer. Concepts applicable to picture communications system standards are considered in what follows on a layer-by-layer basis.

A typical picture call might involve a viewer and remote camera as follows:

A viewer implemented as a picture-call specific client application using a presentation layer optimized for a real-time picture call,

A session between the viewer application and a remote camera (running it's own layered implementation), employing

Picture-call specific transport layer services, running over

Standard Internet Protocol (IP) network layer services, connected to the Internet via point-to-point protocol (PPP) data session layer, over an

Ethernet physical layer.

At the other end of the picture call, a remote camera might contain a camera application running over a camera-specific presentation layer with integrated session and transport layer services, connected via Bluetooth wireless technology to a nearby network access point, which uses Internet network layer services to connect the camera to a picture communications system server.

This brief introduction highlights only a few aspects of the necessary specifications. Among the other aspects are device and owner registration, name resolution, security, and user interface constraints.

Physical and data session layer. Various existing physical layer and data session layer protocols may be employed for network access. For example, Bluetooth™ wireless technology allows a camera or a viewer to attach to a wide area network through access points and gateway devices.

Network layer. The most widely used network layer protocol is Internet Protocol (IP). Although the picture communications system concepts apply equally well to other networks, an early implementation may connect server and registry functions to the Internet via IP.

Transport, session and presentation layers. The transport, session and presentation layers provide end-to-end communications services to the application layer.

Throughout this document, various services are described, which involve exchanges between devices, between devices and the registry, and between devices and the protocol communications node (i.e. server). Proper functioning of those services in any particular embodiment requires that the exchanges be implemented consistently in all devices. This consistent implementation may be accomplished in part through a picture communications system protocol specification addressing transport, session and presentation layers exchanges and services in detail; and addressing the application layer with regard to such elements as picture file, message structures, and basis user interface guidelines.

### Real Time

Response times should be sufficiently short to ensure that the user experience is substantially immediate. Users should be able to actively share and discuss pictures without being distracted by noticeable delays.

A substantially immediate process enables an originator to alert the selected recipient, and (if accepted or acknowledged by the recipient) then captures and sends the picture to the recipient. In this two-party example, after the initial picture is delivered to the recipient, the recipient might create and return a picture modification file by using built-in, standardized tools for manipulating and annotating pictures.

### Interactive

A picture communications system may support a session during which one or more users may share pictures and picture modification files among themselves. Users should be able to mark, annotate and otherwise manipulate a specific shared image while maintaining views of that image that are synchronized and identical for all users.

A picture communications system may include obtaining a fresh image from a remote camera, sending a fresh image from the user's camera to a remote viewer, and sharing a viewed image with a remote viewer. A picture communications system can also include real-time discussion of an image. To facilitate such discussion, tools may be implemented to enable a user to mark the image by placing a pointer, draw attention to an area using an area selection tool, add labels and other notations to the image, crop the image to eliminate unwanted regions, and otherwise manipulate the image, and then to communicate efficiently the resulting modifications to a remote user for discussion. A sequence of modifications may be added to the same image by different users. A set of modifications associated with a particular picture, which result in a specific view, is referred to herein as a picture modification file. Layering is one way of accomplishing this.

### Secure

Users should be confident that an image is transferred securely, free from unlawful interception. One example of a secure system transports an image across the network without regard to content; that is, it transports the image without network translation, conversion or other picture manipulations. Another example of a secure system enables a device to encrypt an image so that only the intended recipient device may decrypt and use the image. Another example of a secure system enables a device to enter a secure session with another device in such a way as to establish confidence that all exchanges remain confidential. Registry-based authentication and protocol design can support these features. One secure system can be designed using concepts taken from GSM handset and subscriber authentication procedures and algorithms, GSM link-level encryption, and the widely-used “pretty good privacy” (PGP) algorithm used to secure electronic mail between may people, as disclosed for example in Internet Engineering Task Force (RFC 2440). In designing a secure system, the protocol designer may balance a number of factors such security level, complexity, network overhead, and latency in designing an optimal security solution.

### Addressable

Devices should be individually addressable in a consistent and stable manner. Each device should be assigned a unique device address. When connected to a network, each device may have a network address that allows remote access.

A persistent universal resource name (URN) may be associated with each camera and viewer. A world-wide web (WWW) Uniform Resource Locator (URL) is one example of the more general URN. Specific URN assignments may be drawn from a namespace specifically developed for a standardized picture communications system. For example, device naming and addressing may fit within the URN framework evolving within the Internet Engineering Task Force (IETF) (see for example http://www.ietf.org/html.charters/urn-charter.html).

A picture communications system may enable separate registration and identification of users and devices. In this example, both the user and the device (for example, a camera or viewer) may each be identified by a unique URN, each associated with a separate record within the registry. For example, a smart card might contain a subscriber identification number (such as the International Subscriber Mobile Identifier, IMSI, used in GSM wireless handsets) which can be read by a camera or by a viewer, and the camera might contain a equipment identification number (such as the International Mobile Equipment Identifier, IMEI, permanently associated with each GSM wireless handset). In this example, when an intended recipient receives an alert from an remote user who wishes to send a picture call, the recipient may be presented with (a) the originating user name, (b) the originating device name, or (c) both, and then use the received names to decide whether to accept the picture call.

### Discoverable

A directory system can be implemented so that devices may be located so that characteristics of a device may be determined. A directory system maintains records of each registered device with information such as the URN, device address, device characteristics, current network address and current status so that authorized remote users may locate and access the device. Internet concepts for distributed domain name server (DNS) system and public telecommunications network standards for intelligent network (IN) number management provide a solid foundation for distributed registry solutions.

### Accountable

Picture communications may involve the using of remote devices and network resources provided by a third party. A system that accounts for usage enables business models to justify deploying devices and networks and to maintain operation for the benefit of the users. Precise, detailed usage records facilitate accurate billing. Accounting mechanisms may collect detailed usage records without burdening devices or network resources unnecessarily and without compromising basic requirements for privacy.

Accounting mechanisms vary between embodiments; for example one or more of the following business relationships may be provided:

1. User pays a monthly (or other periodic) access charge for use of a registered viewing device;

2. User pays a periodic access charge for access to devices associated with a group;

3. User pays usage charges for access to particular remote devices;

4. Device owner pays the network operator based on traffic generated by remote users' usage of the device;

5. Group owner pays for group member service usage based on detailed usage reports; and

6. Anonymous user prepays for access to certain devices, group or network services.

By separating the user names and device names, and enabling each to have a separate owner, thereby identifying the user (the owner) separately from the device (e.g., the camera or viewer), business models may include devices which can be used by a user in a manner similar to the pay telephone. For example, a user might approach a publicly accessible viewer, prepay for a picture call, and request a picture from a remote camera.

To enable a device owner to charge for device usage, a device could generate a Picture Detail Record (PDR), and then deliver that PDR to an accounting collector.

PDR may be collected for reasons other than settlement of charges for resource usage. For example, a device owner may want a PDR to identify the address of a remote device that accessed the owner's device. A device accessing a remote device that collects PDR could be provided the opportunity to remain anonymous by optingout of usage.

### Forward Compatible

While no system can be designed to be fully future-proof, any new system should provide for enhancements.

### IMPLEMENTATION OF PICTURE COMMUNICATIONS SYSTEM

One embodiment of a picture communications system that enables real-time communication of digitally encoded pictures and associated information is disclosed herein. Picture communication includes the transfer of a digital file referred to herein as a picture file. The picture file is useful to define the various entities involved, as well as to define the image. This section defines terminology for one embodiment, and outlines the services provided by this embodiment of a picture communications system. A comprehensive picture communications system solution is envisioned, enabling a broad population of users to communicate using pictures. The system description covers architecture, primary entities, services, privacy, security, heterogeneous network topologies, mobility, transient network connectivity and other areas.

The functions of the picture camera, picture viewer and picture communications network server are described. The methods for interacting between the three primary entities (camera, viewer and subsystem) are described. The perspective of the camera user and the viewer user are described so that the device functions and the networking services may be better understood. A method includes accounting data collection so that various business models may be contemplated, personal picture storage devices enabling pictures to be received while a viewer is absent, device initialization and registration, authentication mechanisms, and access permission methods. Picture modification techniques and the interactive sharing thereof are discussed; also, group conferencing mechanisms are discussed.

The picture communication system envisioned can provide (i) fast communications of still images between distant locations over public as well as private networks; and (ii) intuitive, natural concepts facilitating rapid adoption by broad population.

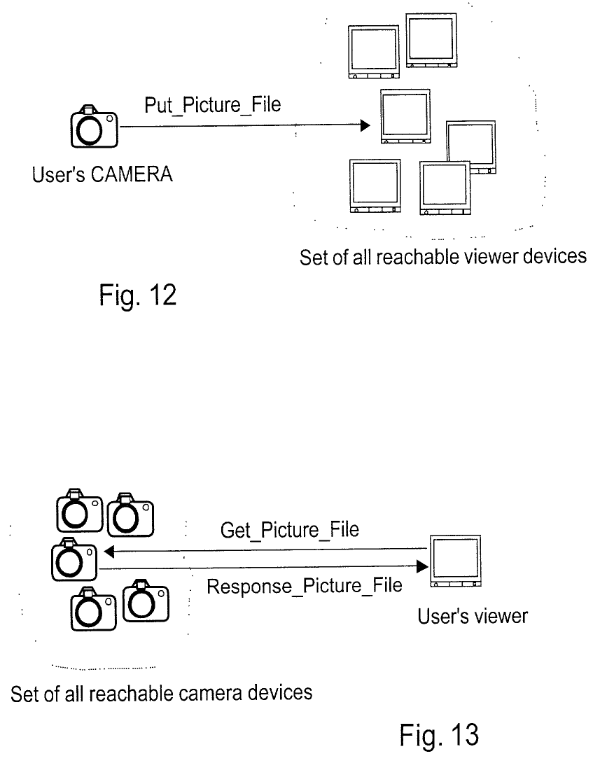

FIG. 12 is a diagram illustrating a process of sending a picture file from a user's camera to a selected viewer. A picture communications system can allow an arbitrarily large population of picture cameras and picture viewers to interconnect without prior coordination. FIG. 12 shows this concept from the point of view of the camera user. A user of a particular camera captures a picture in a digital image file and communicates that picture to a single viewer selected by the camera user from the set of possible viewers. FIG. 13 is a diagram illustrating the process of requesting a picture file from a selected camera I one embodiment, form a set of all immediately reachable cameras. FIG. 13 shows the viewer user selecting a particular camera and issuing a command to retrieve a fresh picture, without intervention at the distant camera and without prior coordination with a user at the distant camera.

Camera and viewer devices may be interconnected through any combination of suitable public and private networks, such as the Internet, private intranets, digital wireless PCS networks, microwave distribution networks, specialized mobile radio networks, and a variety of hybrid networks. Camera and viewer devices may be interconnected by concatenated networks and sessions. For example, a viewer may integrate Bluetooth wireless technology which may be used to access a picture communications system on the Internet through a variety of intermediate networks at different times depending upon which particular network access point is in the vicinity. By such means a user may remain attached to a viewer and move among network access points involving different intervening networks.

A picture communications system includes camera devices which capture pictures, viewer devices with which a user views a picture, one or more picture communication network subsystems, each of which provides registry and other services, users who have certain privileges and service capabilities, owners who register and configure camera and viewer devices, and other elements.

A comprehensive service offering can be implemented and is referred to herein as picture file service. A file structure referred to as a Picture file is discussed. A picture file in one embodiment includes a digitally encoded image, information relating to the creation of the image, and optionally user-created text and/or a digitally encoded audio clip.

One embodiment of Picture service enables a camera user to send (for example using a “Send Picture File” command) a Picture file from a camera to a remote viewer in real time, without prior coordination. Also, the system allows a viewer to get (for example by issuing a “Get Picture file” command) a fresh picture from a camera that is registered and network accessible. That is, a Picture file transfer from camera to viewer may result from a request from either a camera user or a viewer user. A registration process allows the Owner of each camera to set access rights for individual viewers and for groups of viewers

### Definitions

Accept. (verb) The action by a receiving user of accepting a request delivered by an alert message.

Access. (verb) An action of attempting to connect to a user, device and/or group. (noun) The right to access a particular user, device and/or group of users or devices.

Access list. (noun) A list attached to a registry user or device record containing a set of user, device and group names along with Boolean connectors. The access list specifies the users, devices or groups that are allowed attempt access to the user or device which is the subject of that particular record. Boolean connectors permit the use of “or”, “and” and “not” to specify the combinations and sequence of user, device and group names selected by an owner of a user device, or group.

Alert. (noun) A message to a receiving user from a registry and caused by an initiating user requesting to connect with the receiving user for the purpose of exchanging one or more picture files. (verb) The action of communicating an alert message.

Allow. (verb) (a) the process by which a picture communications network subsystem authenticates and enables a request by a requesting user or device to access and/or establish real time communication with a designated user, device, or group; (b) the process by which a picture communications network subsystem authenticates and enables a request by an owner to modify a registry record of an owned entity.

Attach. (v) A user action by which that user becomes associated with a device for the purposes of using network services.

Attached. (noun) The state of a user between the time that user successfully attaches to a particular device and the time that user is detached from that device.

Camera. A device that captures a visual image and communicates the image to another device in a manner compliant with a picture communications system protocol specification.

Connect. (verb) An action by which two or more users and devices become able to put and get (as defined herein) picture files between one another within the time span of a session. Each user or device may be concurrently connected to one or more users, devices, and groups. While connected, users may put and get one or more picture files between connected devices and between connected users. From a protocol standpoint, devices connect above the transport level; the picture communications system does not rely upon connection-oriented services from the transport or lower layers.

Device. (n) A named element capable of exchanging picture files with another device and exchanging messages with a registry, all in a manner compliant with a picture communication system protocol specification.

Get. (verb) An action initiated by a user or viewer device for the purpose of obtaining a picture file from a camera. (noun) A message from a viewer soliciting a picture file from a camera. A get message is a get request.

Group. A set of users, devices such as cameras and viewers, and/or other groups, with associated connect and access rights and rules. A group is created and maintained within a registry by an owner. A group may serve one or more functions. For example, in one function termed a group exploder, a picture file directed to the group is redirected to all group members listed on the recipient list for that group, in a manner analogous to an electronic mail exploder. In this example the registry entry for the group includes a list of recipients to whom requests to put a picture file directed to the group will be directed, in addition to an access list of users, devices and groups whose members may access the recipients as a group. In another function termed a group filter, a group name is included in the access list of an entity (user, device or other group member) so that the access list of the entity effectively includes the access list of that group.

If the access list of a particular user is limited to one group, then only requests from sources named on the access list in that group may reach that particular user. A special case of this group filter function places the group name as the sole entry in the access list of each listed user or device; the effect of this is to create a closed user group in which the members may receive requests (for example, to put or get picture files) from other members exclusively.

Join. (n) An action by which a user may enter the recipient list of a group based upon being included among the optional recipient list.

Name. (n) An identifying word unique within the namespace of a particular registry and assigned to an element as a label for the purpose of addressing that element.

Named. (adj) An element with an assigned name.

Owner. Every device and user listed within a picture communications network subsystem registry is associated with an owner. An owner may be an individual registered user and an owner may be a registered group. The owner of a registered device, such as a camera or a viewer, has authority to define capabilities associated with that device, set access rights for that device camera (viewer), and set configurable parameters on that camera or viewer. For example, an owner may change configured information relating to a camera (viewer) which is registered by that owner. A group owner is an individual who registers a particular group, selects Users who are granted access rights associated with that group, and enables particular camera and viewer devices to be associated with that group.

Picture file. A digital file containing a visual image captured by a camera, source and destination addresses and other associated information, in a format suitable for network transfer to a viewer directly or via temporary intermediate storage. A picture file may contain an audio clip and/or a text file. The optional audio clip and/or text file may be added by the camera as part of image capture, or added subsequently by a user. A picture file may include one or more picture modification file(s). A picture file may contain a view file, together with source and destination addresses and other associated information, in a format suitable for network transfer to a viewer directly or via temporary intermediate storage.

Put. (verb) An action initiated by a user or device with the purpose of delivering a picture file to another user or device. (noun) A message conveying a picture file from a particular user or device to a recipient device or user. A put message is preceded by a put request as part of the put action.

Reject. (noun) The action of denying an alert message. A reject may be explicitly sent by a receiving user or device; reject may be implicit based on expiration of a timer; and a reject may be created by inferred by the picture communications network subsystem based upon an inability to communicate with the receiving device (for example if the receiving device does not respond at the indicated network address).

Redirect. (verb) The action of redirecting a request to connect to another device or user. A receiving user may initiate a redirect upon receiving an alert. Alternatively, a receiving user may set connect rights in the registry to cause connection attempts from particular addresses to be redirected to other addresses.

Request. (verb) An action by which an initiating user device seeks an action by, or response from, a second user, device or group. (noun) A message conveying a request, for example a get picture file request directed to a camera by a viewer.

Register. (verb) An action by which a user record or device record is created within a registry.

Registry. (noun) A database containing user and device records as necessary for the operation of a picture communications system. User records in the registry include user name, owner name, access rights, and the name of any currently attached device. Device records in the registry include device name, class of device (for example, viewer, camera, or combination viewer and camera), access list, network interface address. See FIG. 8 for more information on registry content.

Session. (noun) In the Open Systems Interconnection (OSi) communications model, the Session layer (sometimes called the “port layer”) manages the setting up and taking down of the association between two communicating end points that is called a connection. A connection is maintained while the two end points are communicating back and forth in a conversation or session of some duration. Some connections and sessions last only long enough to send a message in one direction. However, other sessions may last longer, usually with one or both of the communicating parties able to terminate it.

Picture communications network subsystem. A computerized network system, attached to a suitable network such as the Internet, containing a picture communications system protocol front end (termed herein a server) and a registry back end. The picture communications network subsystem stores, within the registry, registration entries for users, devices and groups, along with information on the current status and network addresses of registered users and devices. The picture communications network subsystem processes registration requests, database update requests by owners, picture file exchange requests (e.g., Get_Picture_File and Send_Picture_File), registry queries and other actions.

User. (n) A named person. Among the actions a user may take, user may attach to a device, access registry services, connect to another user or device, join a group; detach from a device, disconnect from a user or device, leave a group, accept an alert, put a picture file to another device or user, get a picture file from another device, register a device while acting as owner of that device, and act become an owner.

Viewer. A device capable of receiving and displaying an image in a manner compliant with a picture communications system protocol specification. A viewer may be an application running within a computing device capable of displaying a picture file and capable of performing other functions. A viewer may also be embedded within a device specifically designed for this function. A camera and viewer may exist in a single device. A camera may include a digital image display but not include a viewer, if (for example) the device is not capable of receiving and displaying a picture file from an external source. A viewer is also capable of receiving and displaying a picture modification file associated with a picture file.

View (or view file). A digital file containing (i) one or more stored picture(s), each of which may be associated with one or more picture modification files, (ii) layout instructions describing the placement of the pictures on a viewer screen, and (iii) sequencing instructions describing the order of display of referenced pictures and picture modification files, timing for display of each element in the sequence, and allowed user actions so that the viewer will display a time sequenced progression of images in a predetermined manner. A view file may be embedded within a picture file for communications via a picture service.

### User's View

A user can perform many different operations. For example a user can operate a camera device that can capture and send a picture, or a viewer device that can receive and display a picture, or a device which supports the functions of both a camera and viewer.

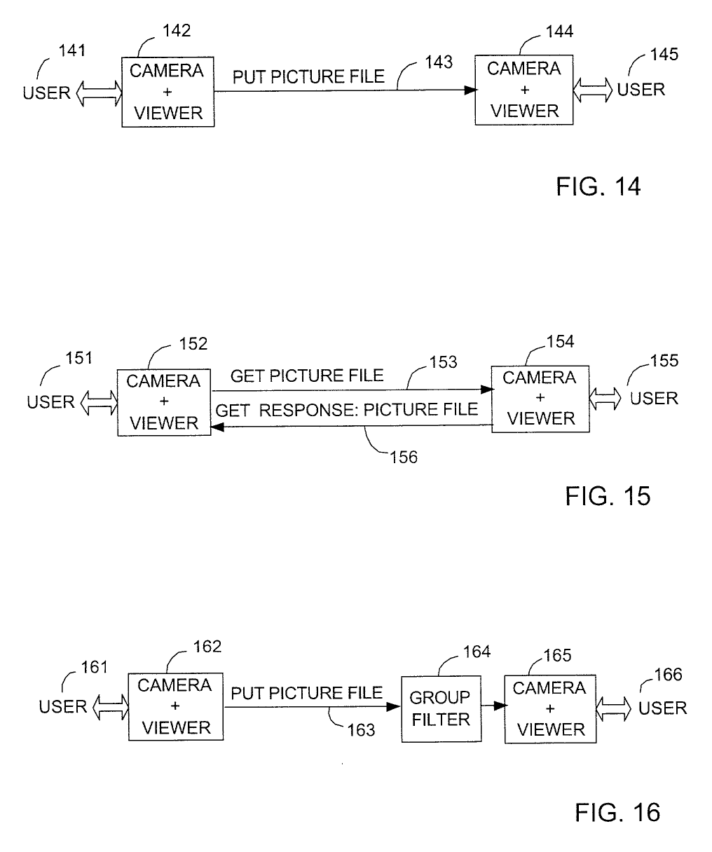

FIGS. 14, 15, 16, 17, 18 and 19 are diagrams that provide several examples of how users might make use of a picture communications system.

FIG. 14 is a diagram of an arrangement wherein a first user puts a picture file to a second user. In FIG. 14, a camera 142 user 141 can send a picture 143 to a designated viewer 144 provided user 141 is on the access list of user 145 and/or of viewer 144.

FIG. 15 is a diagram of an arrangement wherein a first user gets a picture file from a second user. In FIG. 15, a user 151 of viewer 152 can request (get_picture_file 153) a picture 156 from a selected camera 154 provided user 151 is on the access list of camera 154 (or on the access list of user 155, provided user 155 is attached to camera 154).

FIG. 16 is a diagram of an arrangement wherein a first user puts a picture file to a second user through a group filter. In FIG. 16, a user 161 of camera 162 can send a picture 163 to a user 166 attached to a viewer 165 subject to a group 164 filter function, provided user 161 is on the access list of the group 164 providing the filter function for viewer 165 or user 166.

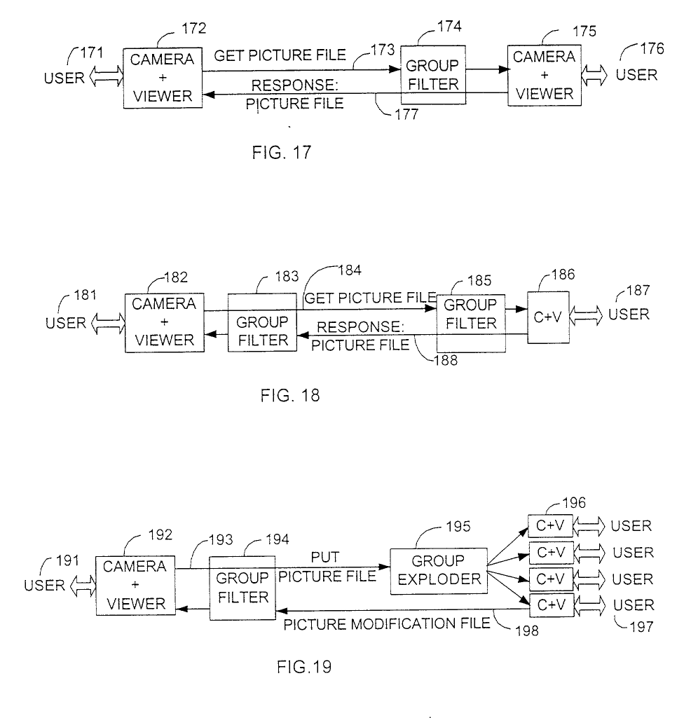

FIG. 17 is a diagram of an arrangement wherein a first user gets a picture file from a second user through a group filter. In FIG. 17 a user 171 attached to a viewer 172 can request (get_picture_file 173) a picture 177 from a camera 175 subject to a group 174 filter function if the requesting user 171 is on the access list of the group 174 providing the filter function for user 176.

FIG. 18 is a diagram of an arrangement wherein a first user gets a first picture file from a device through a first group filter affiliated with the first user, and the first user also gets a second picture file from a second user who is affiliated with a second group filter. In FIG. 18, a user 181 attached to a viewer 182 subject to a group 183 filter can get 184 a picture 188 from a camera 186 subject to a group 185 filter function, provided the requesting user 181 is on the access list of the group 185 filtering access to the selected camera 186 and further provided the selected camera 186 is on the access list of the group 183 filtering access to the requesting user 181.

FIG. 19 is a diagram of an arrangement wherein a first user puts a first picture file from a device through a group exploder filter to multiple users, and at least one of the multiple users modifies the first picture file and puts it through a group filter to the first user. In FIG. 19, a camera user 191 can send a picture 193 to a group of viewers 196 provided the sending user 191 is named on the access list of the group 195 providing the group exploder function to the receiving viewers 196 and users 197, and as further shown in FIG. 19, a user 191 sending a picture file 193 to a group 195 can receive a picture modification file 198 from a member user 197 of the group 195 receiving the picture file 193, provided the user 197 sending the picture modification file 198 is named on the access list of the group 194 filtering access to the intended recipient of the picture modification file (user 191).

Relating to the use and sharing of pictures, a viewer user may be provided with a number of options, depending upon the embodiment:

1. store a picture in his viewer;

2. select, retrieve and display a picture stored in his viewer;

3. select, retrieve and invoke a picture modification file (i) associated with a particular picture, (ii) describing a set of picture editing actions, inserted shapes, inserted pointers, text tags and other visual markings, and (iii) which, when invoked, generates a modified view of the particular associated picture;

4. define a view, consisting of (i) one or more stored picture(s), each of which may be associated with one or more picture modification files, (ii) layout instructions describing the placement of the pictures on a viewer screen, and (iii) sequencing instructions describing the order of display of referenced pictures and picture modification files, timing for display of each element in the sequence, and allowed user actions so that the viewer will display a time sequenced progression of images in a predetermined manner;

5. send a picture to a remote viewer and to a group;

6. send a picture modification file to a remote viewer and to a group;

7. send a view to a remote viewer and to a group;

8. receive a picture from a remote camera;

9. receive a picture from a remote viewer;

10. receive a picture modification file from a remote viewer;

11. receive a view from a remote viewer.

A viewer may be a discrete, single-function device. A viewer may be an application program running within a host computer, using the host computer display, operating system, storage system, keyboard, pointing device and communications services.

### Picture Call

Relating to the communicating of pictures, a viewer user in this embodiment can do any of the following:

1. request a picture from a selected camera;

2. request a picture from a selected viewer;

3. accept a picture from a remote camera;

4. accept a picture from a remote viewer;

5. open a session with a designated viewer for the purpose of sending and receiving pictures and picture modifications; and

6. open a session with a designated group for the purpose of sending and receiving pictures and picture modifications to and from all other members of the group who also have a session open with the group.

Actions 1 through 4 above are discrete transactions between devices, and may in some cases be performed without establishing a session between the devices.

Actions 5 and 6 involve establishing and maintaining a session between devices, during which multiple transactions may take place. The duration of time for action 5 between the initial attempt to open a session and end of session may be referred to as a picture call.

### Network View

Camera devices and viewer devices communicate over one or more networks. Commands, responses and pictures are transported by the network between devices. Each device is identified by a network address which is specific to the network and the access point.

Devices may move. That is, devices may change network access point and therefore network address. To accommodate device movement, a picture communications device registry is installed in the network. The registry allows a device to register with a unique name from a specific network address, so that another device can locate the current network address of a registered device by name.

### Address Resolution

Each device is registered with a device name, and an initial network address. The device name is unique across all devices within the confines of a particular namespace, so that the device may be unambiguously addressed by name. A device name is associated with one and only one unique device address. A device name is selected by the device owner through the registration process, and name uniqueness is enforced during that registration process.

A Uniform Resource Name (URN) namespace may be established for picture communication devices in accordance with Internet Engineering Task Force (IETF) evolving concepts for URN. See for example “http://www.ietf.org/html.charters/urn-charter.html” on the World Wide Web. In this example, a Namespace identifier (NID) may be assigned by the Internet Assigned Numbers Authority (IANA).

An example of a specific device identifier may be “urn:pictal123456789abc” where the part “12345678abc” represents twelve hexadecimal characters corresponding to an assigned media access control (MAC) address drawn from the Institute of Electrical and Electronic Engineers (IEEE) Standard 802 address space. This example may be relevant for a device with an embedded Ethernet adapter or Bluetooth™ wireless technology device, each of which includes a globally unique device address assigned by the manufacturer according to IEEE Standard 802. Alternatively, a specific device identifier may be based upon the identification structure associated with a wireless network devices. For example, the Global System for Mobile (GSM) network standard set by the European Telecommunications Standards Institute (ETSI) is used by hundreds of millions of subscribers worldwide. In GSM, each handset device is assigned a globally unique International Mobile Equipment Identifier (IMEI) which is physically stored within the handset; and each subscription is assigned a globally unique International Mobile Subscriber Identifier (IMSI), which is physically stored within a Subscriber Identity Module (SIM) inserted by the subscriber into a GSM handset. In this example, a specific device physically associated with a GSM terminal might be assigned an identifier in which the IMEI is an integral element, and that specific device might be associated in the Registry with a network address based upon the GSM IMSI associated with the GSM terminal with that IMEI (by virtue of a SIM containing the IMSI being installed within the GSM device with the IMEI). Other device identification schemes and other namespace definitions are also possible.

The registry associates device name, current network address, last known network address and an owner for each device. Also, for each device, the registry maintains a record of groups in which the device is a member. For each registered device, the registry also maintains a record of user, device and group names whose members are allowed privileges with respect to the registered device. A device containing both viewer and camera may utilize a single device address.

Individual devices are addressed by device name, which the registry maps to a current network address. The registry may query a device at a particular network address and request the device address to verify the device identity.

### Device registration

At any time after a device is first attached to a network, a user may invoke a new device registration process. To register the device manually, the user should know (i) the device name, (ii) an initialization key and/or other parameters stored in the device along with the device name, (iii) the network address through which the device may be contacted, and (iv) the network address of a selected registry (for example, the world wide web URL of the registration web page for that registry).

The user connects with the public Web site of the selected registry. The user begins new device registration by completing a form over a secure hypertext tag protocol (https) session using commonly available Internet browser technology. Next, the user causes the registry to connect to the subject device using the supplied (i) device name, (ii) device initialization key and (iii) network address through which the device may be contacted. When connected, the registry authenticates the initialization key through a secure process. When authenticated, the registry next collects device information from the device. The user is now identified as the owner of the registered device. The user (now the owner) may now enter configuration information, modifying default information on the device, register a unique name for the device, enter a longer descriptive name for information purposes, and define other devices and users who may be allowed to contact the device.

A device may be registered automatically if the device has the capacity to locate a registry on a network. Upon locating a registry, an initial registration process identifies the device to the registry and opens a record using a name either preprogrammed into the device or entered into the device by a user. The device registration enters a pending state the accesses the registry, for example through a public web site, identifies the device name and an authentication key embedded in the device and accessible only to someone in physical control of the device. Once authenticated, the owner can complete the registration.

### Redirection for Hidden Devices

The registry also offers a redirection service. A device registration may indicate that the network address is not to be provided to any other device. In this case, a picture communications action intended for the hidden device is addressed to hidden device by name at the network address of the registry. Based on the request, the registry sends the appropriate command to the hidden device using the network address securely stored at the registry. The hidden device may choose to reply (1) directly to the other device or (2) indirectly by addressing a reply to the registry for forwarding to the other device.

### Accounting for Usage

The network and attached cameras and viewers are assets owned and operated by different parties with a variety of business interests. The network may provide accounting services. Each device may be configured to generate a picture detail record (PDR) for each action taken in response to a request from a remote device The PDR is forwarded to an accounting server for processing. Each PDR identifies the action requested, the device address of the requesting party and the responding party, the time and date, and the disposition of the request. A PDR may comprises one or more of the following:

1. Originating device name

2. Destination device name

3. Responsible party

4. Event type (e.g., picture transfer)

5. Event size (e.g., file size)

6. Time stamp (32 bits; time and date)

7. Duration of event (e.g., a session or a group call)

### Picture File

A standard picture file format for exchange among devices is important for the embodiment of the picture communications system envisioned herein. While some flexibility in parameters is possible, for example to permit a small number of picture resolution choices, it is important that one basic mode be universally adopted, and that a specific set of variations be supported on all devices.

Each image contained in a picture file may be encoded using a standard format such as the Joint Photography Experts Group (JPEG) encoding algorithms, in a file format compatible with JPEG File Interchange Format (JFIF).

picture files may contain additional information in a standard, precisely defined format for use by the envisioned picture communications system. Pictures may be uniquely identified within the picture file by originating device name and a time stamp.

In this example, the originating device should synchronize timing with the network-based registry. This enables a viewer to determine the actual time of origin of a specific picture file.

A conference is an ad hoc connection among more than two devices. In a Conference, a picture is sent to all viewers in the conference by the originating device. That is, an originating device wishing to share a picture originates “N−1” messages if there are “N” devices active in a conference.

### Security

The registry may supply the following security functions and services:

1) Device authentication, using the initialization number and device address by the owner at the time of registration;

2) Public key storage for each registered device, which may be used for such purposes as authentication, message integrity and non-repudiation.

Picture file services may include mechanisms for supporting confidential transport of a picture file between source and destination device. When a viewer requests a picture from a camera, the viewer may specify that the picture be transported using confidential mechanisms.

For example, picture file service may rely upon public key encryption mechanisms and upon public key storage in the registry. In this example, the viewer sends its public key to the camera as part of the request. The camera uses its private key and the viewer's public key to encrypt the picture. The viewer obtains the camera's public key from the registry, and uses that public key together with the viewer's own private key to decrypt the picture.

To prepare an encrypted picture for delivery to another viewer in this example, an originating viewer obtains the destination viewer's public key from the registry. The originating viewer uses that public key together with it's own private key to encrypt the picture. The destination viewer obtains the public key of the originating viewer from the registry and uses that public key together with its own private key to decrypt the picture. When establishing a picture call session, one or both viewers may use the public key of the other viewer to initiate a secure session between the viewers. During the initial secure session the viewers may negotiate a unique session key for use during the session.

### Network Interface

A picture communications system device, such as a camera or a viewer, may attach to one or more of a plurality of networks. A device may be attached to a network through a Network Interface (NI). Examples of a NI may include:

1. a cellular handset which may provide digital data transport service to the Internet by means of circuit switched data service over a public cellular network such as one using AMPS, IS-136 TDMA, or IS-95 CDMA technology;

2. a PCS handset which may provide digital data transport service to the Internet by means of circuit switched data service over a wireless digital network, such as a GSM network or a CDMA network;

3. a GSM handset which supports General Packet Radio Service (GPRS) over a GSM network and thence by means of a GPRS Gateway Service Node (GGSN) to the Internet;

4. an Ethernet adapter which is connected to a local area network (LAN) and thence by means of a gateway to the Internet;

5. a product based on Bluetooth T technology and which connects wirelessly over a short range to a network access point by using Bluetooth technology;

6. a cellular network terminal with cellular digital packet data (CDPD) technology and thence by means of a gateway to the Internet

7. a cable modem attached to a cable television facility and supporting digital high speed access to the Internet;

8. a circuit switched dial-up modem connection to an Internet service provider (ISP) over the public switched telephone network (PSTN).

A particular example might combine multiple technologies. For example, a camera might include a Bluetooth wireless technology interface, through which it attaches to a GSM handset that also includes Bluetooth wireless technology,

A Network Interface may be assigned a network address by the network with which it is associated. A Network Interface may be assigned a unique device address which is permanently associated with the physical device. A Network Interface which is permanently associated with the picture communications system device may have a single unique device address useful in its function as a network interface device and in its function as a picture communications system device.

### Picture Answering Machine

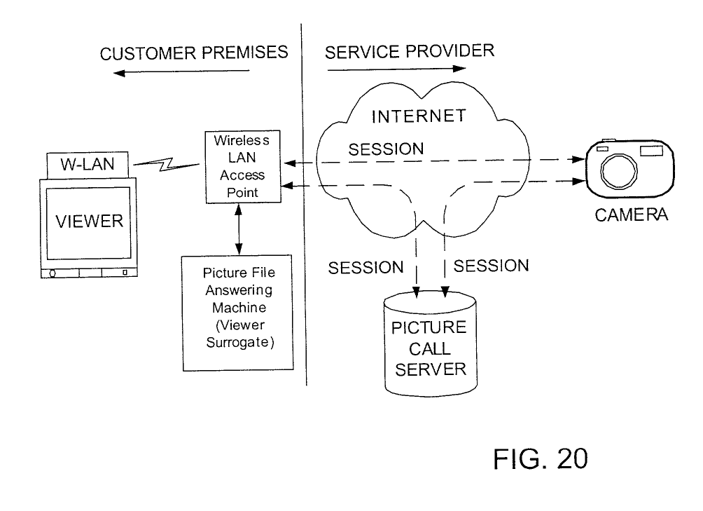

FIG. 20 is a schematic diagram illustrating a picture-file answering machine interposed between the viewer or connected to the viewer and the communication network such as the internet. In FIG. 20, a picture answering machine is a user interface device that may act as a surrogate viewer while a viewer device is detached from the network. A picture answering machine might be described as a device clone, in that it stores the associated viewer's device address and characteristics, and remains attached to the network address registered for the device address.

A picture answering machine may be configured by the user in a variety of ways, for example (1) to receive and store pictures sent to the viewer associated with the picture answering machine, (2) to answer a picture call from devices with permission to call the viewer.

A picture answering machine may enable a user to detach a viewer from the network temporarily without missing attempts by another device to deliver a picture or initiate a picture call.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. A picture communications network subsystem for providing real-time picture communication services, comprising:
one or more protocol communications nodes connected to one or more networks, said one or more nodes providing communication between said network and said picture communications network subsystem;
a registry that includes
user information for a plurality of users, including a user name that uniquely identifies each user, access information, and an owner of each user,
device information for a plurality of devices, including a device name that uniquely identifies each device, access information, and an owner of each device, and
group information for a plurality of groups that provide access rights to users, devices, and other groups, including a group name that uniquely identifies each group, access information, and an owner of each group; and
a control subsystem including a system for establishing real-time communication services between users, devices, and groups responsive to a request by a user or a device.

2. The picture communications network subsystem of claim 1 wherein said control subsystem includes a system for attaching a user to a device so that said user is associated with said device during the time period while the user is attached to said device.

3. The picture communications network subsystem of claim 2 wherein said control subsystem includes a system for locating said attached device, thereby providing a system to locate said attached user.

4. The picture communications network subsystem of claim 1 wherein said control subsystem includes a system for using said user information to determine access rights of a selected user to other users, devices, and groups.

5. The picture communications network subsystem of claim 1 wherein said control subsystem includes a system for using said device information to determine access rights of a selected device to users, other devices, and groups.

6. The picture communications network subsystem of claim 1 wherein said control subsystem includes a system for using said group information to determine access rights of a selected group to users, devices, and other groups, and said group information includes recipient lists and access lists.

7. The picture communications network subsystem of claim 1 wherein said control subsystem further comprises a system for registering a user in the registry, including a system for creating a user record and populating said record with user information relating to said user.

8. The picture communications network subsystem of claim 1 wherein said control subsystem further comprises a system for registering a device in the registry, including a system for creating a device record and populating said device record with device information relating to said device.

9. The picture communications network subsystem of claim 1 wherein said control subsystem further comprises a system for registering a group in the registry, including a system for creating a group record and populating said group record with group information relating to said group.

10. A method for communicating image data between a first and a second user, comprising the steps of
using a picture communications system to open a substantially real time still image communication session between said first and second users;
transmitting said image data from said first user to said second user during said open communication session;
displaying an image responsive to said transmitted image data; and
viewing said image by said recipient.

11. The method of claim 10 further comprising the step of using the picture communications system to establish a voice communication session.

12. The method of claim 10 further comprising said first user selecting said second user and requesting that said picture communications system establish said real time communication session.

13. The method of claim 10 further comprising said second user selecting said first user and requesting that said picture communications system establish said real time communication session.

14. The method of claim 10 further comprising the step of capturing a digital image by said first user during said session, and communicating said digital image substantially in real time.

15. The method of claim 10 further comprising the step of capturing a digital image by said first user previous to said session, and communicating said digital image during said session.

16. A method for communicating image information between a sender and a recipient, comprising the steps of
selecting a recipient;
connecting to a picture communications network subsystem;
utilizing said picture communications network subsystem to establish a session between said sender and said recipient, including
alerting said recipient substantially immediately by transmitting an alert from said sender to said recipient,
responsive to said alert, sending an acknowledgment by said recipient, and
responsive to said receipt of said acknowledgement by said sender, establishing communication services to enable said session; and
transmitting a digital image from said sender to said recipient during said session.

17. The method of claim 16 wherein if said recipient does not acknowledge within a predetermined time period, then establishing a communication session with a location predetermined by said recipient, forwarding said digital image to said predetermined location, and storing it at said predetermined location.

18. The method of claim 16 further comprising the step of capturing a digital image by said sender during said session, and communicating said digital image substantially in real time to said recipient.

19. The method of claim 16 further comprising the step of transforming said digital image into a predetermined picture file format before transmitting said digital image.

20. The method of claim 16 further including the step of establishing a voice session and transmitting a voice message during said session.

21. The method of claim 16 further comprising the step of viewing said digital image by said recipient in a viewer.

22. The method of claim 21 further comprising the steps of editing said image, annotating said image with text and marking said digital image by said recipient, and transmitting said edited, annotated, and marked digital image to said sender during said session.

23. The method of claim 22 further comprising the steps of transmitting a file indicative of said edited, annotated and marked digital image during said open communication session.

24. The method of claim 21 further comprising the step of verbally annotating said digital image by said recipient, and transmitting said verbal annotations to said sender during said session.

25. The method of claim 21 further comprising annotating said image with text and markings by said recipient, and transmitting said annotated digital image to said sender during said session.

26. The method of claim 25 further comprising the steps of editing and annotating said previously annotated file by said sender, and transmitting said edited and annotated file to said recipient.

27. The method of claim 16 further comprising the step of previewing said digital image by said sender in a viewer.

28. The method of claim 27 further comprising the step of annotating said digital image with text and markings by said sender, and transmitting said annotated digital image during said session to said recipient.

29. The method of claim 16 wherein the step of establishing said session includes setting up services over a wireless system.

30. The method of claim 29 wherein said step of establishing said session includes setting up network services from a group comprising: digital wireless wide area networks including cellular and personal communication systems (PCS) including packet data services such as GPRS over GSM technology, PSTN, the Internet, CDPD (cellular digital packet data) service, digital telephone service, and an Intranet.

31. The method of claim 16 further comprising establishing said session over a network, and utilizing a short range wireless link that connects a device operated by one of said sender and recipient to a network interface with said network.

32. A method for viewing an image by a viewer using a remotely-positioned camera, comprising the steps of:
connecting over a network to a picture communication network subsystem;
using said network subsystem to identify a plurality of remotely-positioned cameras;
selecting, by said viewer, one of said plurality of remotely-positioned cameras;
determining, by said network subsystem, that said viewer has the right to access said remotely-positioned camera;
locating, by said network subsystem, said remotely-positioned camera;
sending a request from said viewer to said remotely-positioned camera using said picture communications system, said request including an instruction to capture a digital image;
responsive to said request, establishing network services that enable a substantially real time communication session with said remotely-positioned camera;
capturing a digital image using said remotely-positioned camera;
transmitting said digital image from said remotely-positioned camera to said viewer in substantially real- time over said open communication network; and
viewing said digital image by said viewer.

33. The method of claim 32 wherein said request includes one or more instructions selected from the group comprising: camera aperture, shutter speed, focal length, image resolution, and flash setting, and further comprising the step of controlling said remotely-positioned camera in accordance with said one or more instructions during said image-capturing step.

34. The method of claim 32 further comprising the step of accessing said remotely-positioned camera over a wireless system.

35. The method of claim 32 further comprising establishing said session over a network, and utilizing a short range wireless link that connects a device operated by one of said camera and viewer to a network interface with said network.

36. A computer-implemented method for networking a plurality of viewers and a plurality of remotely-positioned cameras, comprising the steps of:
registering a plurality of cameras with a picture communication network subsystem, including uniquely identifying each of said plurality of cameras in a registry database;
registering an owner for each camera in said registry database;
registering each of a plurality of viewers with said picture communication network subsystem, thereby uniquely identifying each of said plurality of viewers in said registry database; and
registering a plurality of users in said registry database.

37. The method of claim 36, wherein said step of registering said camera includes the step of connecting said camera to said network server, downloading registration information included with said camera into said server, and associating an owner with said camera.

38. The method of claim 36 and further comprising the step of monitoring the most recent location of each of said cameras and viewers.

39. The method of claim 36 further comprising the step of assigning access rights for each viewer that define such viewer's access rights to each camera.

40. The method of claim 36 further comprising the step of receiving in said server a request from one of said cameras to access at least one of said viewers selected by said camera, and responsive thereto, sending an alert to said at least one viewer.

41. The method of claim 40, further comprising the step of sending an acknowledgement from said at least one viewer to said camera, and opening a communication session between said camera and said viewer for digital image transmission.

42. The method of claim 41 further comprising the step of opening said communication session over a wireless system.

43. The method of claim 36 further comprising the step of receiving in said picture communication network subsystem a request from one of said viewers to access at least one of said cameras selected by said viewer, and responsive thereto, opening a communication session between said viewer and said camera for digital image transmission.

44. The method of claim 43 further comprising the step of establishing said communication services for said session over a wireless system.

45. The method of claim 43 wherein said step of opening said communication session over a network selected from a group comprising: digital wireless wide area networks including cellular and personal communication systems (PCS) including packet data services such as GPRS over GSM technology, PSTN, the Internet, CDPD (cellular digital packet data) service, digital telephone service, and an Intranet based upon public specifications.

46. The method of claim 43 wherein said request includes one or more instructions selected from the group comprising: camera aperture, shutter speed, focal length, image resolution, and flash setting, and further comprising the step of controlling said remotely-positioned camera in accordance with said one or more instructions during said image-capturing step.

47. The method of claim 43 further comprising the step of verifying that said viewer has access to said camera, and if not, then not allowing communication between said viewer and said remotely-positioned camera.

48. A method for communicating image information between a first user and a second user, comprising the steps of
utilizing a picture communications system to establish a two-way communication session between said first and second users;
transmitting a digital image from said first user to said second user during said session;
revising said digital image by said second user;
transmitting said revised digital image to said first user during said session.

49. The method of claim 48 further comprising the steps of:
transmitting said digital image to a plurality of users simultaneously with said transmission to said second user, and
transmitting said revised digital image to said plurality of users simultaneously with said transmission of said revised digital image to said first user.

50. The method of claim 49, further comprising the step of re-revising said revised digital image by one of said plurality of users, and transmitting said re-revised image to said first user, said second user, and said plurality of users.

51. The method of claim 48 further including the step of transmitting a voice message over said open communication session.

52. The method of claim 48 further including the step of exchanging verbal communications between said first and second users during said two-way session.

53. The method of claim 48 further comprising the steps of revising by said first user said digital image previously revised by said second user, and transmitting said revised digital image from said first user to said second user.

54. The method of claim 53 further comprising the step of revising said digital image a plurality of times, and exchanging a series of revised digital images between said first and second users.

55. The method of claim 48 wherein said step of transmitting said revised digital image includes transmitting said revisions without the revised digital image over said communication session so that said revisions are efficiently transmitted.

56. The method of claim 55 further comprising the step of receiving said revisions and responsive thereto constructing the corresponding revised digital image.

57. The method of claim 48 wherein the step of establishing communication services includes establishing services over a wireless system.

58. The method of claim 48 further comprising establishing said session over a network, and utilizing a short range wireless link that connects a device operated by one of said first and second users to a network interface with said network.
